(19) United States
(12) Patent Application Publication
(10) Pub. No.: US 2025/0291561 A1
(43) Pub. Date: Sep. 18, 2025

(54) INFORMATION PROCESSING APPARATUS, PROGRAM GENERATION SYSTEM, AND PROGRAM GENERATION METHOD

(71) Applicant: Seiichi KONDO, Tokyo (JP)

(72) Inventor: Seiichi KONDO, Tokyo (JP)

(21) Appl. No.: 19/070,554

(22) Filed: Mar. 5, 2025

(30) Foreign Application Priority Data
Mar. 18, 2024 (JP) 2024-042789
Nov. 21, 2024 (JP) 2024-203050

(51) Int. Cl. G06F 8/35; G06F 8/10; G06F 8/70

(52) U.S. Cl. CPC G06F 8/35; G06F 8/10; G06F 8/70

(57) ABSTRACT

An information processing apparatus communicably connected with a terminal apparatus and a generative artificial intelligence (AI) system via a network, which includes circuitry that: transmits, to the generative AI system, a chat message received from the terminal apparatus, setting information related to generation of a program code, and information for calling a function; receives a request from the generative AI system, the request being transmitted by the generative AI system based on the chat message, the setting information, and the information for calling the function; and with execution of the function, generates the program code related to the request based on a parameter included in the request.

### CROSS-REFERENCE TO RELATED APPLICATIONS

This patent application is based on and claims priority pursuant to 35 U.S.C. § 119 (a) to Japanese Patent Application Nos. 2024-042789, filed on Mar. 18, 2024, and 2024-203050, filed on Nov. 21, 2024, in the Japan Patent Office, the entire disclosure of which is hereby incorporated by reference herein.

### BACKGROUND

### Technical Field

The present disclosure relates to an information processing apparatus, a program generation system, and a program generation method.

### Related Art

Artificial intelligence (AI) has been used in programming. For example, one or more programs are generated based on the contexts obtained from text data representing the conversations, by referring to a program code database, a program grammar analysis database, and an automatic program generation knowledge database. The program code database stores one or more program codes in association with the contexts of the text data. The automatic program generation knowledge database associates operations to be performed with programs made efficient for processing the operations.

### SUMMARY

The present disclosure described herein provides an information processing apparatus communicably connected with a terminal apparatus and a generative artificial intelligence (AI) system via a network. The information processing apparatus includes circuitry that: transmits, to the generative AI system, a chat message received from the terminal apparatus, setting information related to generation of a program code, and information for calling a function; receives a request from the generative AI system, the request being transmitted by the generative AI system based on the chat message, the setting information, and the information for calling the function; and with execution of the function, generates the program code related to the request based on a parameter included in the request.

The present disclosure described herein provides a program generation system including a terminal apparatus and an information processing apparatus communicably connected with the terminal apparatus and a generative AI system via a network. The terminal apparatus includes terminal circuitry configured to transmit a chat message related to an application. The information processing apparatus includes apparatus circuitry that: transmits, to the generative AI system, the chat message received from the terminal apparatus, setting information related to generation of a program code for the application, and information for calling a function; receives a request from the generative AI system, the request being transmitted by the generative AI system based on the chat message, the setting information, and the information for calling the function; and with execution of the function, generates the program code related to the request based on a parameter included in the request.

The present disclosure described herein provides a program generation method performed by an information processing apparatus communicably connected with a terminal apparatus and a generative artificial intelligence (AI) system via a network. The method includes: transmitting, to the generative AI system, a chat message received from the terminal apparatus, the chat message, setting information related to generation of a program code, and information for calling a function; receiving a request from the generative AI system, the request being transmitted by the generative AI system based on the chat message, the setting information, and the information for calling the function; and generating the program code related to the request based on a parameter included in the request, with execution of the function.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example flow of processes performed from the time when a generative AI system requests an information processing system to execute a function in response to a chat message input by a user, to the time when the information processing system generates a program code;

FIG. 2 is a diagram illustrating an example of a system configuration of a program generation system of FIG. 1;

FIG. 3 is a diagram illustrating an example of a hardware configuration of each of the information processing system, a user terminal, and a developer terminal of FIG. 2;

FIG. 4 is a diagram illustrating an example of a functional configuration of the information processing system, the user terminal, and the developer terminal of FIG. 2;

FIG. 5 is a diagram illustrating an example of a customer management application screen displayed by the user terminal of FIG. 2;

FIG. 6 is a diagram illustrating an example function selection screen, which is displayed when a user presses an AI collaboration function button on the customer management application screen of FIG. 5;

FIG. 7 is a diagram illustrating an example of a chat screen displayed when a user presses a customize application button on the customer management application screen of FIG. 5;

FIG. 8 is a diagram illustrating an example of a chat screen displaying a program code generated;

FIG. 9 is a diagram illustrating an example of a customer management application screen and a chat screen displayed when a user presses an OK button of FIG. 8;

FIG. 10 is a diagram illustrating an example of a response message that the information processing system of FIG. 1 acquires from the application service;

FIG. 11 is a diagram illustrating an example of a request message for calling first API, which is published by the generative AI system of FIG. 1;

FIG. 12 is a diagram illustrating an example of a response message that the generative AI system transmits to the information processing system of FIG. 1 in response to the request message of FIG. 11;

FIG. 13 is a diagram illustrating an example of a response message that the generative AI system transmits to the information processing system of FIG. 1 in response to the request message of FIG. 11;

FIG. 14 is a diagram illustrating an example of a program code generated based on a function call request of FIG. 13;

FIG. 15 is a diagram illustrating an example of a response message that the generative AI system transmits to the information processing system of FIG. 1 in response to the request message of FIG. 11;

FIG. 16 is a diagram illustrating an example of a program code generated based on the response message of FIG. 15;

FIG. 17 is a diagram illustrating an example of a request message for calling first API published by the generative AI system of FIG. 1 after the addition of a program code;

FIG. 18 is a diagram illustrating a response message returned by the generative AI system of FIG. 1 in response to the request message of FIG. 17;

FIG. 19 is a sequence diagram illustrating an example process of assisting addition of the program code, performed by the information processing system of FIG. 4;

FIG. 20 is a diagram illustrating another example of a functional configuration of the information processing system and the user terminal of FIG. 1;

FIG. 21 is a first sequence diagram illustrating example operation of adding the program code to the application service by the information processing system using linking of two web browsers of the user terminal of FIG. 20;

FIG. 22 is a second sequence diagram illustrating example operation of adding the program code to the application service by the information processing system using linking of two web browsers of the user terminal of FIG. 20;

FIG. 23 is a diagram illustrating example processes performed so that an information processing system generates a program code for a chat message input by a user; and

FIG. 24 is a diagram illustrating an example of a functional configuration of the program generation system of FIG. 2 in a case where the application service and the information processing system are combined into one system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of an information processing system and a method of generating a program performed by the information processing system are described below with reference to the drawings. In the following embodiments, a user is able to customize one or more functions of application with low codes or no codes using the generative AI system.

### First Embodiment

### Assisting Addition of Program Code by Using Generative AI System

There is a generative AI system such as ChatGPT®. The generative AI system performs various natural language processing tasks, such as text generation, question answering, text classification, sentiment analysis, information extraction, and sentence summarization. Another example of the generative AI system is Copilot®, which proposes codes to be written next while the user is coding a program. Using the generative AI system, in one example, the user can develop the application with low codes or no codes.

The present disclosure relates to the technology in which the user customizes the functions of application through a conversation, such as a chat, with the generative AI system. In the present disclosure, the generative AI system or the functions thereof may be referred to as artificial intelligence (AI).

The generative AI system may be provided as a system different from a system that provides a service related to the application. Further, the service related to the application and the generative AI system may be provided by the same provider.

There is a service that allows the user to create the application such as the web application through a simple operation. The simple operation may be arranging a preset component such as an icon on a screen. Using this service, the user is able to develop the application with low codes or no codes. However, there is a limitation to what can be accomplished by the operation of arranging the component such as the icon on the screen. For this reason, many services allow the user to enter the program codes to customize the functions of the application.

The user who uses such service expects to develop the application with low codes or not codes. In fact, it has been difficult for the user to customize the functions of the application by entering the program codes. Even if the user enters the program codes, the user cannot determine whether the application operates correctly.

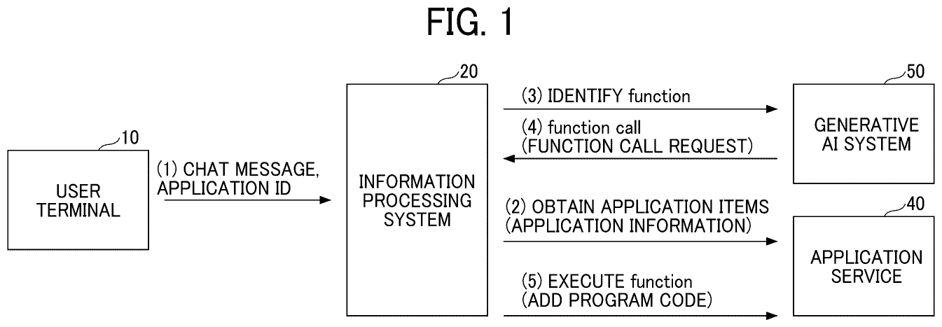

In view of the above, in the present disclosure, by using a function call provided by the generative AI system, an information processing system intervenes between the user and the generative AI system to make it possible for the user to customize the functions of the application with low codes or no codes. To illustrate this process, an example system of FIG. 1 is described. The system of FIG. 1 includes a user terminal 10, an information processing system 20, an application service 40, and a generative AI system 50. In FIG. 1, it is assumed that one or more applications have already been generated.

FIG. 1 illustrates an example flow of processes performed from the time when the generative AI system 50 requests the information processing system 20 to execute a function in response to a chat message input by a user, to the time when the information processing system 20 generates the application. The information processing system 20 provides a user interface for allowing the user to develop the application using the generative AI system 50. The information processing system 20 converts a chat message transmitted from the user terminal 10 into a request message for calling an application programming interface (API) published by the generative AI system 50 and the application service 40, and transmits the request message to the generative AI system 50 and the application service 40.

At (1), the user terminal 10 transmits a chat message input by the user to the information processing system 20. The chat message includes contents to be used for customizing the application such as “Please always designate one person in charge”. The user terminal 10 transmits, to the information processing system 20, an application identifier (ID), which is an example of identification information for identifying the application to be customized.

The user terminal 10 requests the information processing system 20 to customize the application identified with the application ID. To customize the application, information on the items included in the application, which are referred to as the application items, are required. At (2), the information processing system 20 calls an API of the application service 40, and obtains application information such as names of the application items of the application identified with the application ID from the application service 40.

At (3), the information processing system 20 transmits a request message including information on the application items to the generative AI system 50, via an API provided by the generative AI system 50 for receiving the request message. Specifically, the information processing system 20 causes the request message to include settings of the specification of the function (the function specification settings) for transmission. The function is a program interface that performs a preset process with a specified argument and returns a return value as a result. This function is a function for enabling the generative AI system 50 to request the information processing system 20 to customize the application. The information processing system 20 transmits the request message that includes the settings of the specification of this function to the generative AI system 50. In response to a request for the function call from the generative AI system 50, the information processing system 20 can customize the application with low codes or no codes. The above-described request to the information processing system 20, which is made by the generative AI system 50 to call the function, is referred to as the function call, or the function call request. As the supplementary information, the information processing system 20 may include, in the request message, system settings for notifying the generative AI system 50 of information related to the program code such as cautions. The system settings and the function specification settings will be described in detail below. The system settings represent the general policy for the application to be created. The function specification settings include information regarding the specification of the function to be called by the generative AI system 50, and specified by the information processing system 20 for the generative AI system 50.

The information processing system 20 may not include the system settings and the function specification settings in the same request message as the request message including information on the application items. For example, the information processing system 20 may include the system settings and the function specification settings in a request message different from the request message including information on the application items, and transmit the request message including the system settings and the function specification settings to the generative AI system 50. The information processing system 20 may also transmit the system settings and the function specification settings to the generative AI system 50 separately with different request messages.

The information processing system 20 may transmit the system settings and the function specification settings each time the information processing system 20 transmits the request message including information on the application items, or may transmit the system settings and the function specification settings only once with the request message that is firstly transmitted.

At (4), the generative AI system 50 transmits a response message including a function call request (function call) to the information processing system 20, based on information on the application items, the system settings, and the function specification settings that are included in the transmitted request message. The generative AI system 50 requests the information processing system 20 to call a function. The function is actually executed by the information processing system 20.

The generative AI system 50 does not necessarily transmit a response message including a function call request to the information processing system 20 based on the conversation history, the function specification settings, and the system settings. For example, the generative AI system 50 may transmit a response message including a question or a response message indicating that the contents of the application items are not interpretable to the information processing system 20.

At (5), the information processing system 20 generates a program code for customization in response to the function call request included in the response message transmitted from the generative AI system 50, and requests the application service 40 to add the program code. The response message includes not the program code itself but program information. The program information is information such as JavaScript Object Notation (JSON) for generating a program code, and is in a JSON format which is a predetermined format. Accordingly, the information processing system 20 can easily generate the program code. Alternatively, the response message may include the program code itself.

The information processing system 20 generates a request message for calling the API of the application service 40 from the contents of the function call request (function call), and transmits the generated request message to the application service 40. In the present disclosure, the process related to generation of a request message may be referred to as “execution of a function” or “executing a function”. In the embodiment of FIG. 1, the information processing system 20 adds the program code to the application service 40 in response to the function call request (function call).

As described above, the user at the user terminal 10 only enters the contents of the application to be customized in the natural language. The information processing system 20 then generates the program code using the program information received from the generative AI system 50, and adds the program code to the application service 40.

### Terminology

The application is an abbreviation of an application program. In this disclosure, the application is a program generated by a computer according to a certain task. An Operating System (OS) is general-purpose software that provides basic functions and systems for operations performed by the computer such as the file system, communication, and display control. The application provides specific functions while operating on the OS. Examples of the application include a web application and a native application. In the present disclosure, any of the web application and the native application may be developed.

The API is an interface for the application (software), which serves as a contact point where the systems that are connected share functions and mechanisms. The API defines the specification of an interface used by the applications to exchange information with each other. The API between the computers defines, for example, the specification for one web site to communicate with another web site by HTTP (HTTPS) communication. Through communicating, the one web site may use the functions provided by the other web site. The API between the computers may be referred to as a Web-API.

When the API transmits a specific request (for example, data acquisition, update, deletion, or processing), the API returns a result (for example, data, an update result, a deletion result, or a processing result) in response to the specific request. The request may be referred to as a request message, and the result may be referred to as a response message. Calling the API means transmitting a request and acquiring a result in accordance with the specification of the API. Calling the API may also be referred to as executing, operating, tapping, or using.

The information for calling a function is information that enables a function provided by the information processing system 20 to be called from the outside of the information processing system 20, for example, from the generative AI system 50.

The information for calling a function includes information related to the Web-API for calling a function.

The information related to the Web-API for calling a function is information for enabling the generative AI system 50 to call (use) the Web-API. In the present disclosure, the information related to the Web-API is referred to as setting of the function specification settings. The function specification settings include information regarding the specification of the function to be called by the generative AI system 50, and specified by the information processing system 20 for the generative AI system 50.

The generative AI system 50 calls the function to the information processing system based on the function specification settings, so that the information processing system 20 can analyze the function.

The function is a program interface that performs a preset process with a specified argument and returns a return value as a result. The specification and functions of the function may be designed by the developer. The API is prepared in advance such that the function is disclosed to be available to the generative AI system 50 and the application service 40. The function is one example of the specification of the API, and can be set by calling the API when the API defines a method of designating the function. The function call or the function call request refers to a request for executing the function.

The chat service is a service in which a plurality of users transmit and receive messages in real time. The generative AI system is a service in which the user transmits and receives messages to and from the AI in real time.

The setting information is the overall policy for generating the application. The setting information is, for example, a description or a hint of the application, or contents that should not be asked to the user. In other words, the setting information is information that facilitates generation of a desired application if the setting information is shared with the generative AI system 50.

The system settings are information obtained by converting all or a part of the setting information into a request message for calling an API. In other words, the system settings are information obtained by converting all or the part of the setting information to have a format according to the API.

The user is an end user who uses the application provided by the application service 40. The user can also develop the application. The developer is a person who performs settings on the information processing system 20, which are necessary to develop the application with the low-code programming or the no-code programming. The developer sets the setting information, which will be described below, on the information processing system 20.

Customization refers to changing, adding, or deleting the functions of a product or a service according to the need or the preference of the individual. As one example, the application can be customized by adding the program code to the application.

The parameter included in the request is information used for generating the program code.

The parameter may be a parameter included in the application to be generated or may be a parameter not included in the application to be generated. The parameter may be a parameter used for generating the application. The contents of the parameter vary depending on the program code that the user wants to generate. For example, in the case of generating the application that handles a table format or a database, the parameter is used to determine, for example, whether required data has been set or whether the data format is correct. In the present disclosure, the parameter is described in JsonLogic. The parameter includes a name of the application item (“item name) to which the program code is added. The parameter may also describe a logic using the item name.

The program code is data used for giving an instruction to the computer. Examples of the program code include the description in a programming language, data (for example, machine language or object data) converted by a complier for processing by the computer, and an assembly language. The program code may be written in, for example, JsonLogic, HTML, JavaScript, PHP, Ruby, Visual Basic, Python, Go, C #, or C++.

### Example of System Configuration

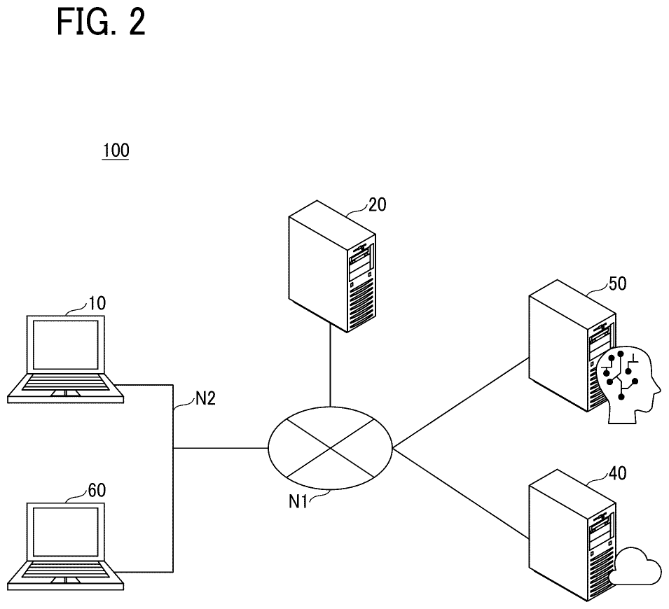

A system configuration of a program generation system 100 is described with reference to FIG. 2. FIG. 2 is a diagram illustrating an example of a system configuration of the program generation system 100. The program generation system 100 illustrated in FIG. 2 includes the information processing system 20, the user terminal 10, and a developer terminal 60. The information process system 20 and the user terminal 10, and the information processing system 20 and the developer terminal 60 are communicably connected with each other via networks N1 and N2. The information process system 20 communicates with the generative AI system 50 and the application service 40 via the network N1. The application service 40 may be an external system external to the program generation system 100. The user terminal 10 and the developer terminal 60 communicate with the generative AI system 50 and the application service 40 via the networks N1 and N2.

The user terminal 10 and the developer terminal 60, which are provided at facilities such as companies or homes, are connected to the network N2. The network N2 may be a local area network (LAN), Wi-Fi®, wide-area Ethernet®, or a mobile phone network such as 4G, 5G, or 6G. The network N1 may be a wide area network such as the Internet or a WAN. The user terminal 10 and the developer terminal 60 do not always need to be connected to the network N2. The user terminal 10 and the developer terminal 60 may be connected when the information process system 20, the generative AI system 50, or the application services 40 is used.

The generative AI system 50 provides a service for the user to make a conversation with the AI. The generative AI system 50 may be based on the large language model (LLM). The large language model is a model designed for the natural language processing, which is trained using a large amount of text data. The generative AI system 50 is input with a vast amount of text, and obtains knowledge from the input text, for example, by deep learning or reinforcement learning. The generative AI system 50 uses the obtained knowledge to output a response message to data based on the chat message. The generative AI system 50 includes an interface that receives data input by the user, such as a chat message or an electronic file. The data such as the chat message or the file received by this interface is referred to as a prompt. As described above, the prompt may include the chat message in the natural language such as an instruction or a question, or the electronic file. The chat message may be a part of the conversation or words in the natural language spoken by the human. One example of the electronic file is an image. The generative AI system 50 that generates a sentence with respect to the chat message may be referred to as the generative AI. In the present disclosure, the information processing system 20 generates an application that operates on the application service 40 by using a response message, which is responded by the generative AI system 50 to the chat message input by the user. The application that operates on the application service 40 includes a web application that operates on the application service 40 and a native application that is installed on the user terminal 10. When the native application installed on the user terminal 10 is executed by the user terminal 10, the native application is connected to the application service 40 and executes the functions of the application service 40.

The generative AI system 50 has the following features.

First, the generative AI system 50 can keep the natural flow of conversation.

Second, the generative AI system 50 can make a proposal by expanding ideas even in the field that the user has no knowledge.

Third, the generative AI system 50 can call a function, which can be used to generate program code.

The information processing system 20 can keep the natural flow of conversation with the user, via the generative AI system 50. The user can have ideas that may be necessary for the application to be generated, by giving an instruction about the application to be created. The function called by the generative AI system 50 is accurate and highly reproducible. Using the called function, the information processing system 20 can easily generate the program code desired by the user.

The generative AI system 50 may be based on LLM such as GPT-3®, GPT-4®, Transformer®, or BERT®. It is assumed that the program generation system 100 uses the ChatGPT based on GPT-3 or GPT-4 as an example. Alternatively the program generation system 100 may use any other LLM.

The application service 40 is one or more information processing apparatuses that provide the application to be executed by the user. The application provided by the application service 40 is, for example, a database-based web application that manages data in a table format. The user may customize the application, for example, by freely setting the fields of the application to store, read, or process data related to the user's business. Setting of the fields of the existing database as desired by the user is one example of application development. Controlling details of the database functions is one example of application customization.

In the example of FIG. 2, the information processing system 20 generates a request message including a chat message from the user, and transmits the request message to the generative AI system 50. The information processing system 20 adds the program code to the application service 40 by using the response message from the generative AI system 50. In other words, the user can customize the application provided by the application service 40 with no codes.

In the case where the application service 40 and the information processing system have different domains, for example, due to different sources of the services, the application service 40 and the information processing system 20 have different accounts even for the same user.

Alternatively, the application service 40 and the information processing system 20 may be combined into one system. For example, the application service 40 may include the functions of the information processing system 20, or the information processing system 20 may include the functions of the application service 40. In another example, the application service 40 and the generative AI system 50 may be combined into one system. In another example, the generative AI system 50 and the information processing system 20 may be combined into one system. In another example, the information processing system 20, the application service 40, and the generative AI system 50 may be combined into one system.

Examples of the application service 40 include a cloud service, an application service provider (ASP), and SaaS, and may include various services to be provided via a network. Examples of the service to be provided include a database providing service and a storage service. The application service 40 may reside on the Internet or may reside on-premises.

The information processing system 20 transmits the chat message transmitted from the user terminal 10 to the generative AI system 50. The information processing system 20 may be implemented by one or more information processing apparatuses. The information processing system 20 operates as a server that receives a request from the user terminal 10. The server is a computer or software that performs process of providing information or a processing result in response to a request from the client. The information processing system provides a user interface to the user terminal 10, generates a request message from the received chat message, and transmits the generated request message to the generative AI system 50. Further, when the information processing system 20 receives a request (function_call) for adding a program code from the generative AI system 50, the information processing system 20 requests the application service 40 to add the program code. The user does not have to cause the user terminal 10 to switch a connection destination between the generative AI system 50 and the application service 40.

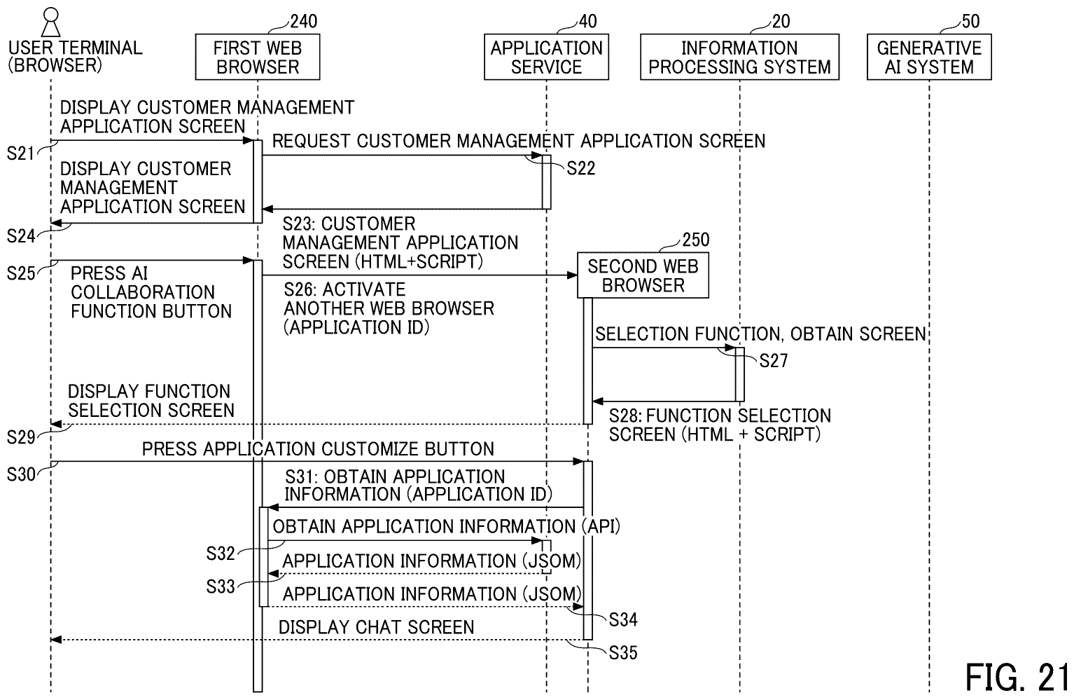

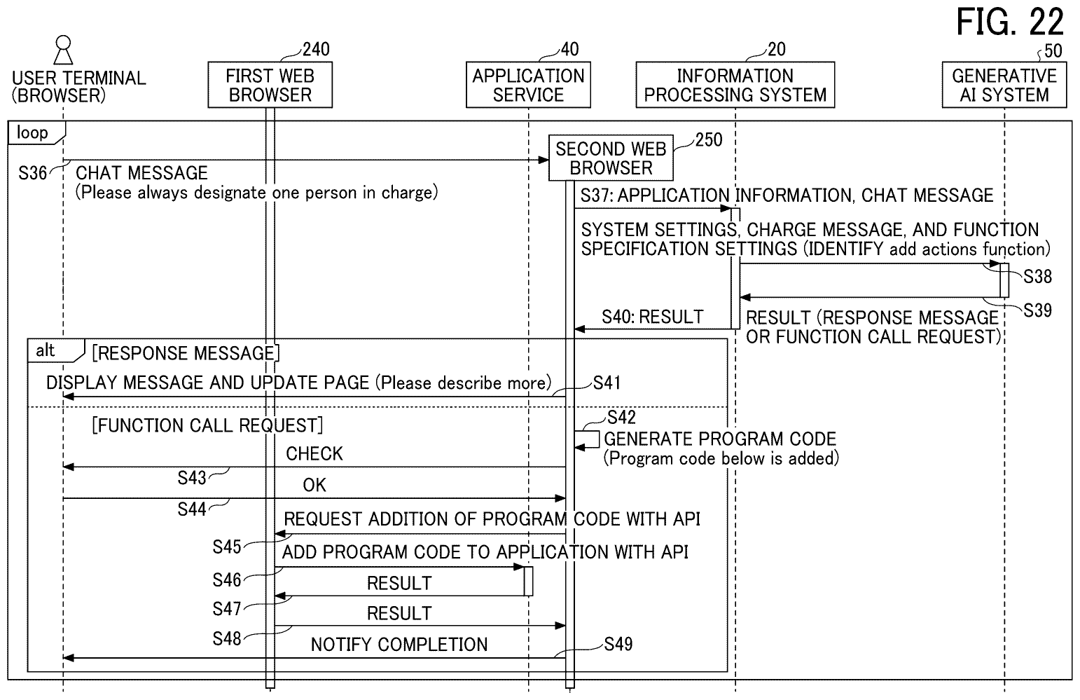

As will be described below, the user may add a program code by using the application service 40 as a portal. The information processing system 20 receives a connection request to the generative AI system 50 from the user terminal 10 connected to the application service 40, and communicates with the generative AI system 50. The communication with the generative AI system 50 is described in detail with reference to FIGS. 21 and 22.

The information processing system 20 receives settings of setting information from the developer terminal 60. The settings of the setting information is to set knowledge (setting information) to the information processing system 20, which is required to generate the application of the application service 40 or to generate the program code. The setting information is information to be used by the generative AI system 50 to add the program code. The setting information may include, for example, the notification regarding the program code such as the cautions. Through setting the setting information to the information processing system 20 by the developer, it becomes easier for the information processing system 20 to assist the user in developing the application.

The information processing system 20 generates the system settings related to the application based on the setting information in an appropriate manner, and notifies the generative AI system 50 of the generated system settings. The system settings, which are generated from the setting information, are a part or all of the setting information.

The setting information is previously set to the information processing system 20, for example, before the user starts developing the application or adding the program code. The information processing system 20 may customize the setting information for each customer. For example, when the setting information is “you will have a conversation with a customer of $$ business from now” based on the business type of the customer, the information processing system 20 changes the business type name $$ according to the business type of the customer, and notifies the generative AI system 50 of the changed business type name.

The information processing system 20 generates a request message to be transmitted to the generative AI system 50 using the setting information. Alternatively, the setting information may not be provided. This is because the information processing system 20 can acquire the application items from the application service 40, and the generative AI system 50 has learned the grammar of the programming language. The setting information in the request message is reflected in the system setting described below. The details will be described later.

The information processing system 20 may be implemented by cloud computing or may be implemented by a single information processing apparatus. The “cloud computing” refers to internet-based computing where resources on a network are used or accessed without identifying specific hardware resources. The information processing system 20 may be present on the Internet or on the premises.

The functions of the information processing system 20 may be distributed over a plurality of information processing apparatuses. For example, a plurality of information processing systems 20 having the same functions may be provided. The number of information processing systems that distribute data, such as a moving image, may be increased or decreased according to the processing load.

The user terminal 10 or the developer terminal 60 is, for example, a terminal apparatus such as a personal computer (PC), a smartphone, or a tablet terminal, which is operated by the user or the developer. The web browser or the native application operates on the user terminal 10 or the developer terminal 60.

The developer operates the developer terminal 60 to generate the setting information related to the application.

The user operates the user terminal 10 to input the chat message. The administrator or the user operates the developer terminal 60 or the user terminal 10 to use various services provided by the information processing system 20, the generative AI system 50, or the application service 40.

The user terminal 10 or the developer terminal 60 may be implemented by an information processing apparatus. Examples of the information processing apparatuses include an output apparatus such as an electronic whiteboard or a digital signage, head-up display (HUD), an industrial machine, an imaging apparatus such as a digital camera, a sound collecting apparatus, medical device, network home appliance, a mobile phone, a smartphone, a tablet terminal, a car navigation system, a game machine, a personal digital assistant (PDA), and a wearable PC.

### Example of Hardware Configuration

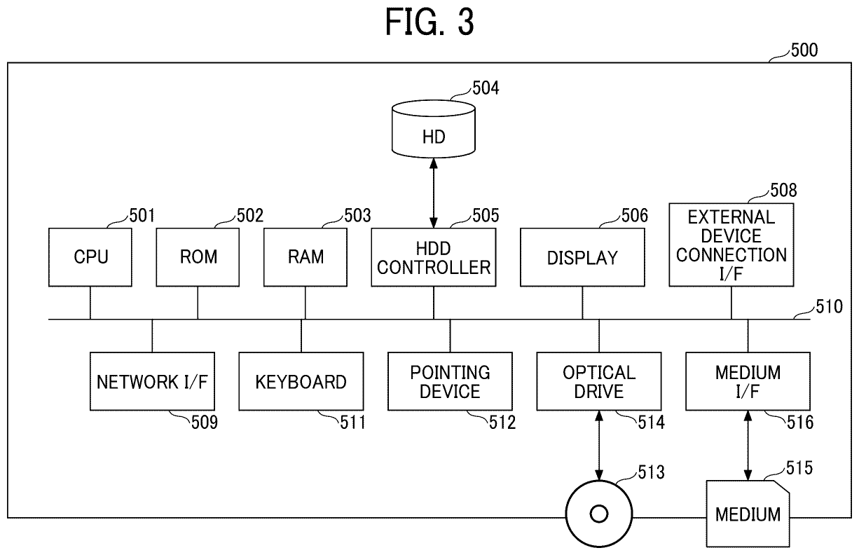

The hardware configuration of any one of the information processing system 20, the user terminal 10, and the developer terminal 60 included in the program generation system 100 is described with reference to FIG. 3. The generative AI system 50 and the application service 40 may each have the same hardware configuration as that of FIG. 3. Alternatively, the information processing apparatus 20, the generative AI system 50, and the application service 40 may each have a hardware configuration of the information processing apparatus applicable to cloud computing, such as a server residing on the network. For example, the information processing apparatus operating as the server does not have to include the display 506, the keyboard 511, or the pointing device 512.

### Information Processing System, User Terminal, and Developer Terminal

FIG. 3 is a diagram illustrating an example of a hardware configuration of each of the information processing system 20, the user terminal 10, and the developer terminal 60. As illustrated in FIG. 3, the information process system 20, the user terminals 10, and the developer terminals 60 are each implemented by a computer 500. The computer 500 includes a CPU 501, a ROM 502, a RAM 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516.

The CPU 501 controls entire operation of the computer 500. The ROM 502 stores a program for executing the CPU 501, such as an initial program loader (IPL). The RAM 503 is used as a work area for the CPU 501. The HD 504 stores various data such as software programs. The HDD controller 505 controls reading and writing of various data from and to the HD 504 under control of the CPU 501. The display 506 displays various information such as a cursor, a menu, a window, text, or an image, and may be implemented by a liquid crystal display (LCD). The external device connection I/F 508 is an interface circuit that connects the computer 500 to various external devices. Examples of the external devices include, but are not limited to, a universal serial bus (USB) memory and a printer.

The network I/F 509 is an interface circuit for performing data transmission using the network N2. The bus line 510 is, for example, an address bus or a data bus for electrically connecting the components illustrated in FIG. 3, such as the CPU 501, with each other.

The keyboard 511 is an example of an input device that includes a plurality of keys for inputting characters, numerical values, various instructions. The pointing device 512 is another example of the input device that allows the user to select or execute a specific instruction, select a target for processing, or move a cursor being displayed. The optical drive 514 reads and writes various data from and to an optical drive 513. The optical drive 513 may be, for example, a digital versatile disc-recordable (DVD-R) or a digital versatile disc-recordable and rewritable (DVD-RW). The medium I/F 516 controls reading and writing (storing) of data from and to a storage medium 515 such as a flash memory.

### Functions

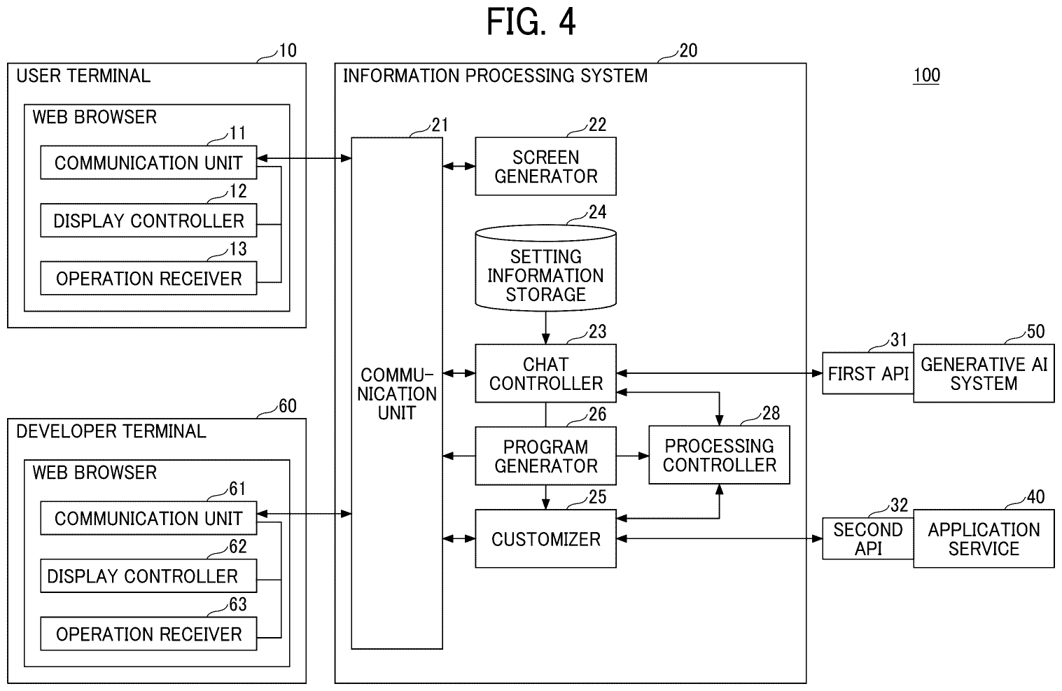

A functional configuration of the program generation system 100 is described below with reference to FIG. 4. FIG. 4 is a diagram illustrating an example of a functional configuration of the information processing system 20, the user terminal 10, and the developer terminal 60.

### User Terminal

The user terminal 10 includes a communication unit 11, a display controller 12, and an operation receiver 13.

These functional units are functions or means that are implemented by the CPU 501 illustrated in FIG. 3 executing instructions included in one or more programs installed in the user terminal 10. For example, the communication unit 11, the display controller 12, and the operation receiver 13 may be implemented by the web browser or JavaScript® executed by the CPU 501. When the user terminal 10 executes the native application, these functional units may be implemented by the native application.

The communication unit 11 transmits and receives various types of information to and from the information processing system 20. The communication unit 11 receives screen information of a customer management application screen from the application service 40. The communication unit 11 further receives screen information such as a chat screen on which chat messages are input from the information processing system 20. The communication unit 11 transmits chat messages and operation information on the user terminal 10 to the information processing system 20. The communication unit 11 may directly communicate with the generative AI system 50.

The display controller 12 interprets the screen information of various screens and displays the screens based on the screen information on the display 506.

The operation receiver 13 receives various user operations on various screens displayed on the display 506, which may be input with the keyboard 511 or the pointing device 512.

### Developer Terminal

The developer terminal 60 includes a communication unit 61, a display controller 62, and an operation receiver 63. These functional units are functions or means that are implemented by the CPU 501 illustrated in FIG. 3 executing instructions included in one or more programs installed in the developer terminal 60. For example, the communication unit 61, the display controller 62, and the operation receiver 63 may be implemented by at least one of the web browser or JavaScript® executed by the CPU 501. When the developer terminal 60 executes the native application, these functional units may be implemented by the native application.

The communication unit 61 transmits and receives various types of information to and from the information processing system 20. The communication unit 61 receives screen information used for inputting setting information from the information processing system 20. The communication unit 61 transmits the setting information or the operation information on the developer terminal 60 to the information processing system 20. The communication unit 21 may also communicate with the generative AI system 50 or the application service 40.

The display controller 62 interprets the screen information of various screens and displays the screens based on the screen information on the display 506.

The operation receiver 63 receives various user operations on various screens displayed on the display 506, for example, via the keyboard 511 or the pointing device 512.

### Information Processing System

The information processing system 20 includes a communication unit 21, a screen generator 22, a chat controller 23, a setting information storage 24, a customizer 25, a program generator 26, and a processing controller 28. These functional units of the information processing system 20 are functions or means that are implemented by the CPU 501 illustrated in FIG. 3 executing instructions included in one or more programs installed in the information processing system 20. The setting information storage 24 is implemented by a memory such as the HD 504 or RAM 503 illustrated in FIG. 3. The setting information storage 24 may not be included in the information processing system 20. For example, the setting information storage 24 may be provided on the network as long as it is accessible by the information processing system 20.

The communication unit 21 transmits and receives various types of information to and from the user terminal 10. For example, the communication unit 21 transmits the screen information of the customer management application or the chat screen to the user terminal 10. The communication unit 21 receives chat messages input by the user from the user terminal 10. The communication unit 21 further transmits and receives various types of information to and from the developer terminal 60. The communication unit 21 further transmits the screen information of an input screen of the setting information to the developer terminal 60. The communication unit 21 receives the setting information input by the developer from the developer terminal 60, and stores the setting information in the setting information storage 24.

The screen generator 22 generates the screen information of various screens (web pages) displayed by the user terminal 10 and the developer terminal 60. The web page is provided as a part of the web application. The screen information is a program described in, for example, HyperText Markup Language (HTML), JSON, Extensible Markup Language (XML), a script language, or Cascading Style Sheet (CSS). The structure of a web page is mainly specified by HTML, the operation of the web page is defined by a script language, and the style of the web page is specified by CSS. The user terminal 10 may execute the native application. The native application is an application that cannot be executed unless the application is installed in the user terminal 10. In the case of the native application, the screen information is stored in the user terminal 10, and the information to be displayed is transmitted in, for example, JSON or XML.

The chat controller 23 calls a first API 31 to transmit a request message to the generative AI system 50. The request message includes, for example, a name of the application item and the function specification settings. When the chat controller 23 receives the chat message transmitted from the user terminal 10, the chat controller 23 transmits a request message including the received chat message to the generative AI system 50. The chat controller 23 may transmit a request message including the conversation history to the generative AI system 50, before and after transmitting the chat message or together with the chat message. The first API 31 is one or more APIs published by the generative AI system 50. As a result of calling the first API 31, the chat controller 23 receives a response message to the request message from the generative AI system 50. The response message includes a response message to the chat message, or the function call request to the information processing system 20 and the program information.

The program generator 26 interprets the program information included in the response message from the generative AI system 50, and generates the program code. For example, the program information is described in a JSON format based on JsonLogic. JsonLogic is a simple grammar for handling data. The information process system 20 can describe tasks such as simple conditional branching, mathematical expression calculation, or data filtering by using JsonLogic.

The customizer 25 calls a second API 32 to transmit a request message to the application service 40. The customizer 25 functions by executing a predefined function. The request message includes the program code to be added to the application. The program code may include logic using the name of the application item or the data of the application item.

The second API 32 is one or more APIs published by the application service 40. As a result of calling the second API 32, the customizer 25 receives a response message to the request message from the application service 40. The response message includes a result (success or failure) of the request for adding the program code. The result indicating the success means that the program code is registered in the application.

The customizer 25 may customize the application by adding the program code to the application in the information processing system 20 without requesting the application service 40. For example, the customizer 25 may add the program code as a macro that is valid in spreadsheet software.

Examples of the process to “add the program code” not only include the case where the customizer 25 actually adds the program code, but also the case where the customizer 25 requests the other system such as the application service 40 to add the program code and the application service 40 actually adds the program code.

The processing controller 28 determines a process to be performed next based on the chat message transmitted from the user terminal 10 and the button (operation content) pressed by the user. For example, the processing controller 28 requests the chat controller 23 or the customizer 25 to perform the determined process.

### Operation of Generative AI System

The information process system 20 uses the generative AI system 50 by calling the first API 31 published by the generative AI system 50. In other words, the information processing system 20 calls the first API 31 to enable the conversation with the AI, which is one of the functions provided by the generative AI system 50. The following describes the operations or processes by the generative AI system 50.

The information processing system 20 transmits a request message for calling the API to the generative AI system 50 to communicate with the generative AI system 50. With the request message, the information processing system 20 obtains a response message from the generative AI system 50.

Specifically, the generative AI system 50 returns the response message to the information processing system 20 in response to the request message. The contents included in the response message of the generative AI system 50 are often different even if the chat message is the same. If the information processing system 20 specifies a parameter called temperature as 0, the generative AI system 50 returns the same contents of the response message in response to the same chat message.

When the information processing system 20 wants to continue the conversation with the generative AI system 50, it is desirable to include the entire conversation history in the request message. This is because the conversation with the generative AI system 50 is stateless. This is, however, the specification of a certain generative AI system. There may be a case where the conversation history does not have to be included, depending on the specification of the generative AI system 50.

As described above, the first API 31 has no state regarding the past conversations, such that the conversation is stateless. For this reason, the user of the first API 31, for example, the information processing system 20, is required to keep the conversation history, and specify the conversation history every time the first API 31 is called. Alternatively, the conversation history may be held by the user terminal 10. Further, since the first API 31 tends to return an error when the conversation history becomes too long. For this reason, it is preferable that the information process system 20 causes only the latest exchanges of messages to be included in the request message when the conversation continues for a long time.

### Function Call Returned by Generative AI System

The functions provided by the generative AI system 50 include the function known as “function call”. The function call, when executed, causes the generative AI system 50 to request the information processing system 20 to call a specific function. When the information processing system 20 allows the generative AI system 50 to use this function known as “function call”, the generative AI system 50 can call the “function”.

The request message includes the function specification settings set by the information processing system 20, which causes the generative AI system 50 to call the “function”. Based on the function specification settings, the generative AI system 50 executes the function call (function call request). As described above, the function specification settings are information used by the generative AI system 50 to call the customizer 25. Based on the function specification settings, the information processing system 20 notifies the generative AI system 50 that the generative AI system 50 can request the information processing system 20 to call the function.

The information processing system 20 allows the generative AI system 50 to use the function call. Accordingly, the generative AI system 50 calls the function provided by the information processing system 20, and causes the information processing system 20 to execute the function. Based on an execution result of the function, the information processing system 20 can have a conversation with the user.

However, the response messages of the generative AI system 50 are different every time such that the generative AI system 50 does not necessarily make the function call request. For example, even if the information processing system 20 causes the request message to include the function specification settings, the generative AI system 50 may return the same response message as a response message for the case where the function specification settings are not included.

The continuity of conversations between the user and the generative AI system 50 is described below. In the present embodiment, there is no phase in which the continuity of the conversations is preferable. In the case where the entire conversation history is included in the request message, it is preferable to include, in the request message, the execution result of the function executed by the information processing system 20. The request message is then transmitted to the generative AI system 50. However, it is not necessary for the information processing system 20 to include the execution result of the function in the request message, and transmit the request message to the generative AI system 50 together with the conversation history. For example, the information processing system 20 may transmit the execution result of the function to the user terminal 10 as it is. If the information processing system 20 transmits the execution result of the function to the generative AI system 50, the generative AI system 50 can continue the conversation while taking into account the conversation history, so that the continuity of conversations can be maintained. For example, the consistent style and wording are maintained such that the user is less likely to feel uncomfortable. For example, if the user was having conversations in English, the information processing system 20 determines that it does not need to translate the response message into English.

Further, the information processing system 20 cannot predict whether the generative AI system 50 will request the function call. In view of this, the information processing system 20 may explicitly designate the “function_call option” in the request message to cause the generative AI system 50 to call the function.

### Example Screens Displayed by User Terminal

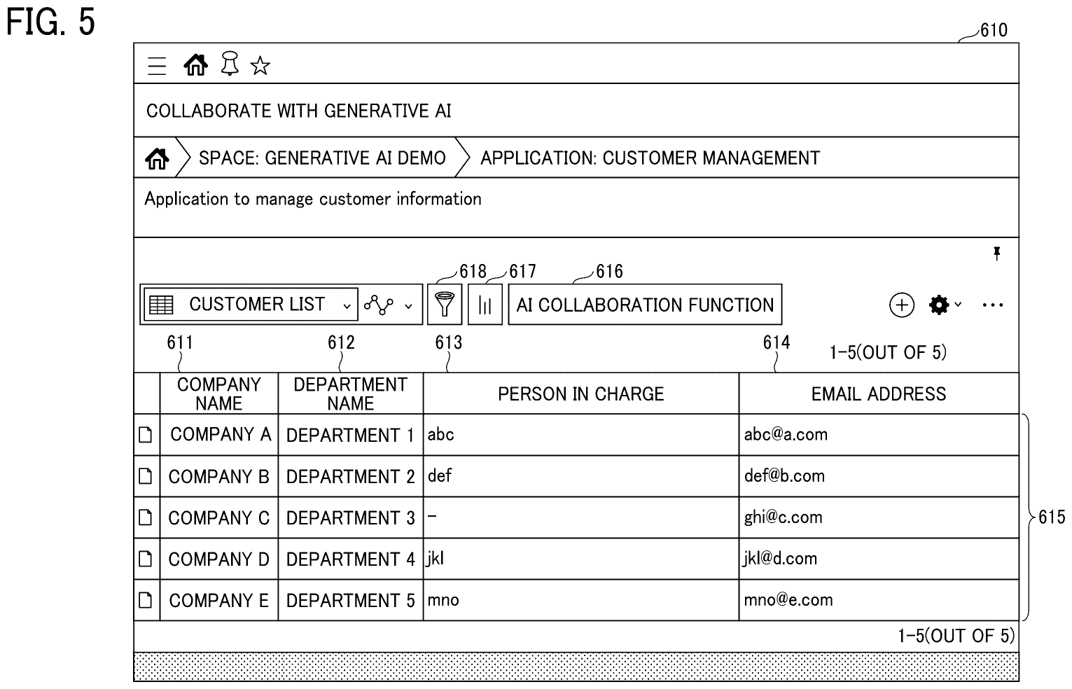

Examples screens displayed by the user terminal 10 when the user customizes the application are described with reference to FIGS. 5 to 9. In FIGS. 5 to 9, the example case where the user customizes the customer management application is described.

FIG. 5 illustrates an example of a customer management application screen 610 displayed by the user terminal 10. The customer management application is a web application executed by the application service 40. The customer management application includes, as items, a company name 611, a department name 612, a name of a person in charge 613, and an email address 614. In this example, five records 615 have been entered. The five records 615 may be dummy data generated by the generative AI system 50 or may be data manually input by the user.

The generative AI system 50 assists the user in customizing the application with no codes or low codes by providing various assistance options. The customer management application screen 610 includes an AI collaboration function button 616, which is a button for displaying assistance options. The customer management application screen 610 includes a filtering button 618 and a calculate button 617. The filtering button 618 is a button to be selected to filter the records under a predetermined condition. The calculate button 617 is a button to be selected to calculate statistical information of the records and illustrate a graph of the statistical information.

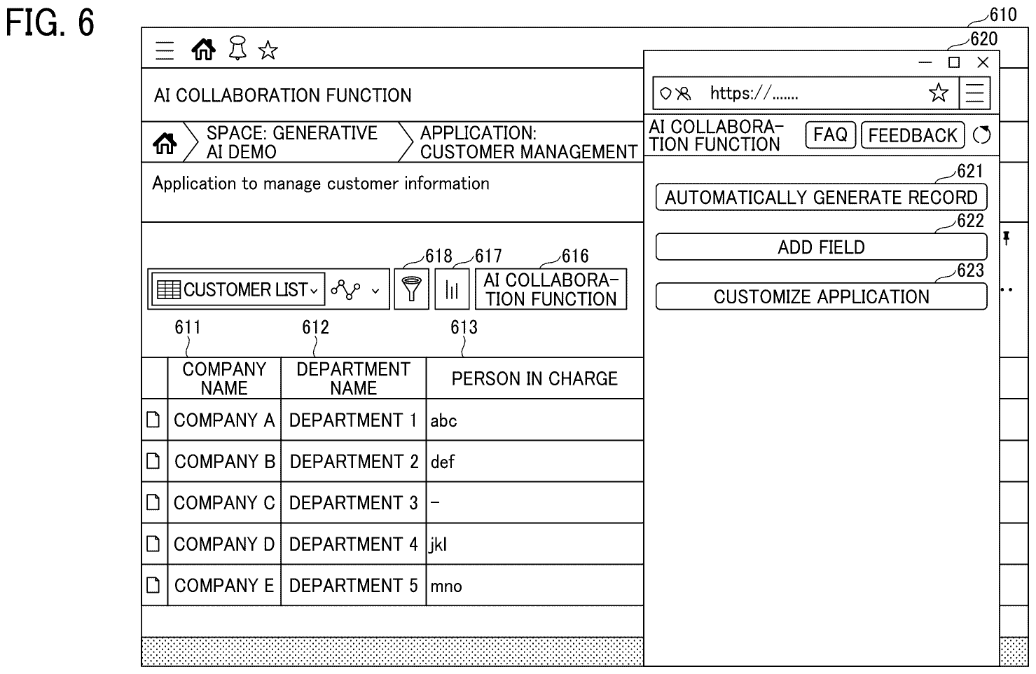

FIG. 6 illustrates a function selection screen 620, which is displayed when the user presses the AI collaboration function button 616. With the pressing of the AI collaboration function button 616 on the customer management application screen 610, an application ID of the customer management application is obtained. The function selection screen 620 of FIG. 6 is displayed as a pop-up window that overlaps the customer management application screen 610, but it may be displayed in various ways. For example, the function selection screen 620 may be displayed after being switched from the customer management application screen 610. The function selection screen 620 includes an “automatically generate record” button 621, an “add field” button 622, and a “customize application” button 623.

The “automatically generate record” button 621 is a button to be selected to automatically generate and register dummy data. The dummy data is data, which is generated to be used for checking the operations or the functions of the application. Without registering the dummy data, the user may check the operations or the functions of the application. The “add field” button 622 is a button to be selected to allow the user to add an item (field) to the customer management application with the support of the generative AI system 50. The “customize application” button 623 is a button to be selected to customize the application with the support of the generative AI system 50.

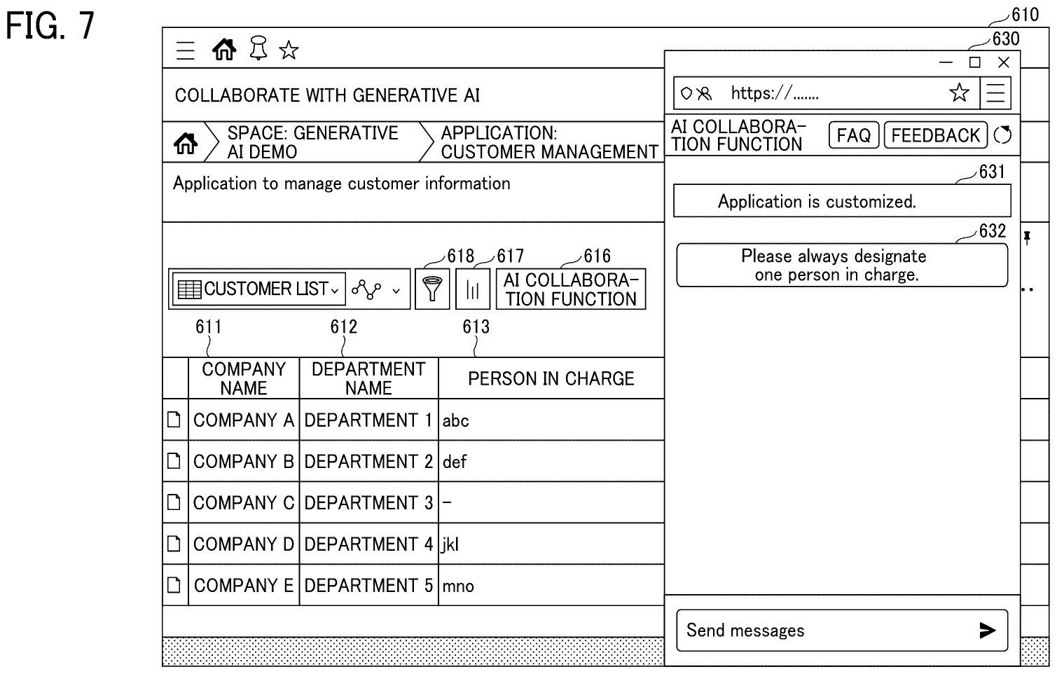

FIG. 7 is a diagram illustrating a chat screen 630, which is displayed when the user presses the “customize application” button 623. The chat screen 630 of FIG. 7 is displayed as a pop-up window that overlaps the customer management application screen 610, but it may be displayed in various ways. For example, the chat screen 630 may be displayed after switching from the customer management application screen 610. The chat screen 630 includes a message 631 indicating that “Application is customized”. It is assumed that the user sees the message 631 and inputs a chat message 632 indicating that “Please always designate one person in charge”.

When the user terminal 10 transmits the chat message 632 to the information processing system 20, the information processing system 20 acquires information on the customer management application, such as an item name, from the application service 40. The information processing system 20 requests the generative AI system 50 to generate program information by designating the information on the customer management application, and obtains the program information from the generative AI system 50. At this stage, the information processing system 20 may register the program code itself in the application service 40. While the generative AI system 50 generates the program code, the generated program code may contain an error. It is not preferable that the generated program code deletes the data of the user due to the error. In view of this, the information processing system 20 causes the generative AI system 50 to generate program information in the JSON format instead of causing the generative AI system 50 to generate the program code. The information processing system 20 generates a program code from the program information and adds the program code to the application service 40.

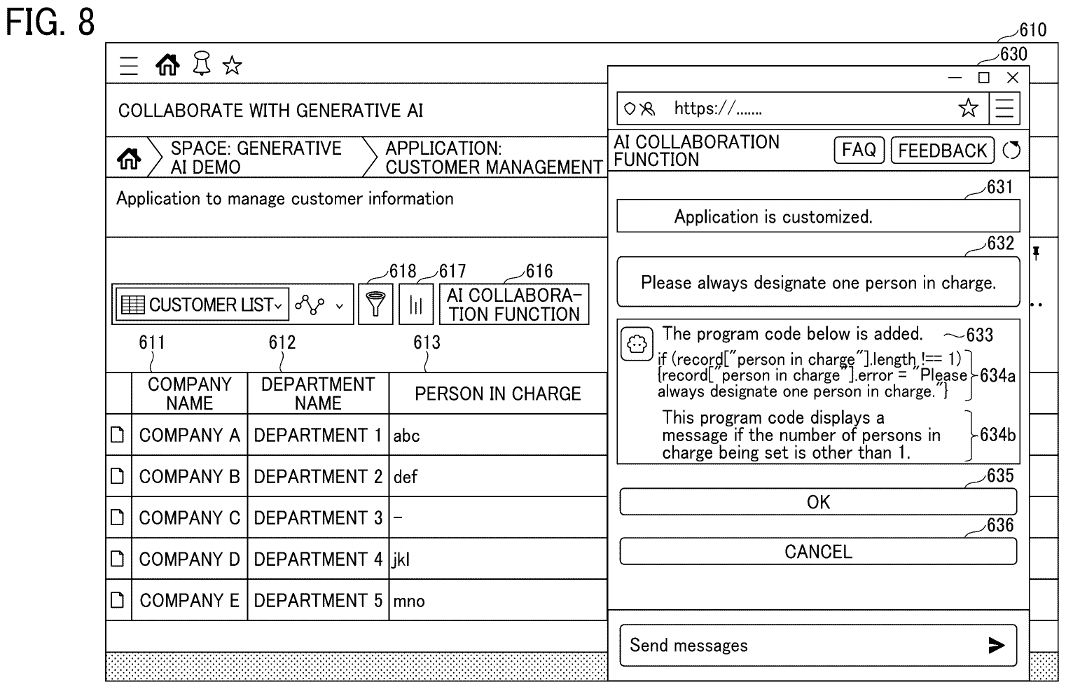

FIG. 8 illustrates a chat screen 630 that displays the generated program code 634a. The chat screen 630 of FIG. 8 includes a message 633 indicating that “The program code below is added.” The message 633 corresponds to a confirmation message for confirming with the user whether the program code is to be added to the application service 40. The chat screen 630 further displays an explanatory text 634b. The explanatory text 634b describes the contents of the program code. The explanatory text 634b may be generated by the generative AI system 50 or may be generated by the information process system 20. The generative AI system 50, which generates the explanatory text 634b, transmits the explanatory text 634b together with the program information.

The chat screen 630 further includes an OK button 635 and a cancel button 636. When the user presses the OK button 635, the information process system 20 registers the program code 634a in the customer management application of the application service 40. When the OK button 635 is pressed, the information processing system 20 determines that the user has confirmed the request for registering the program code generated from the program information included in the request (function_call) from the generative AI system 50.

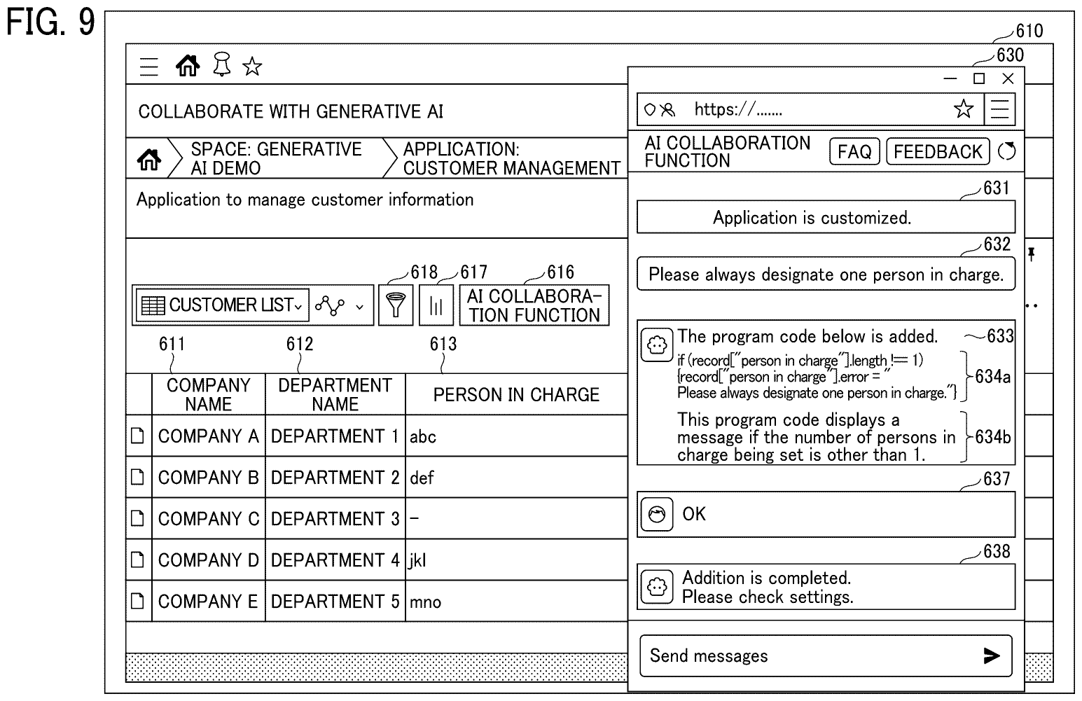

FIG. 9 illustrates a customer management application screen 610 and a chat screen 630, which are displayed when the user presses the OK button 635. The chat screen 630 of FIG. 9 displays a chat message 637 indicating “OK” input by the user pressing the OK button 635, and a response message 638 indicating that “Addition is completed. Please check settings”. Although the customer management application screen 610 has not been changed, the program code 634a is added so that an error message is displayed if the user does not set one person in charge in the record of the customer management application.

### Request Message and Response Message

Examples of a request message and a response message are described. Specifically, the request message transmitted from the information processing system 20 to the application service 40 or the generative AI system 50, and the response message received by the information processing system 20 from the application service 40 or the generative AI system 50 are described.

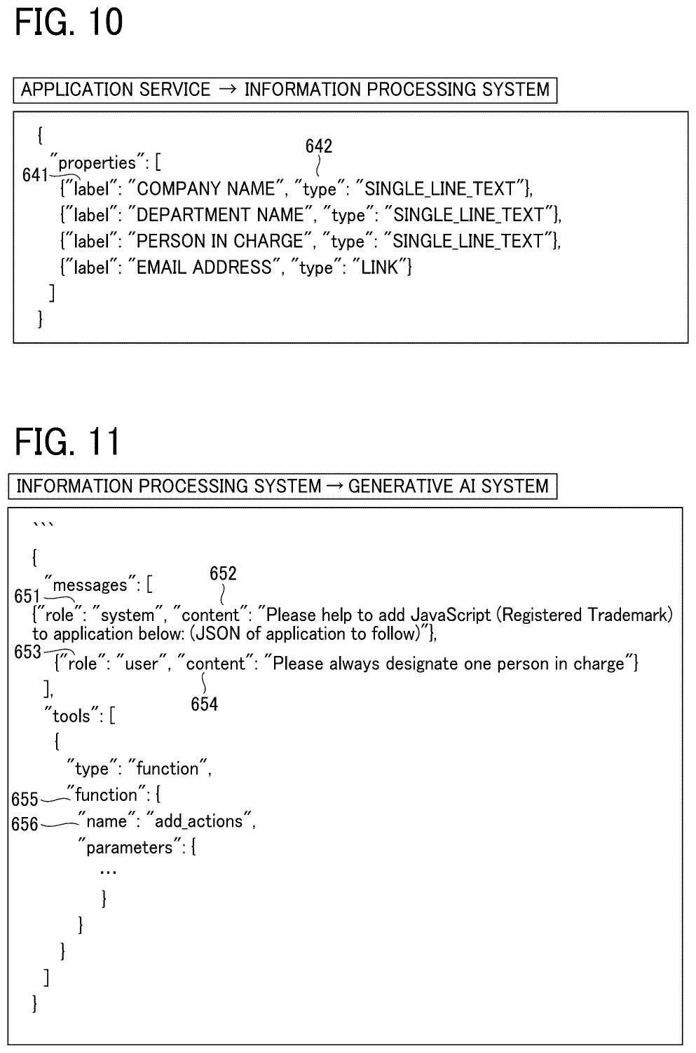

FIG. 10 is an example of a response message that the information processing system acquires from the application service 40. When the user inputs the chat message 632 “Please always designate one person in charge” on the chat screen 630, the customizer 25 generates a request message for calling the second API 32a, and transmits the request message to the application service 40. The request message is generated to include a request for the application ID and the application information such as the item name or the data format. For example, the customizer 25 acquires the response message illustrated in FIG. 10.

In the response message of FIG. 10, label 641 indicates the item name, and type 642 indicates the format. As described above referring to FIG. 5, the company name, the department name, the name of the person in charge, and the email address are each written in association with the label 641. The customizer 25 acquires the application information of the application, such as the item name and the data format, from the application service 40.

The chat controller 23 generates a request message for requesting the generative AI system 50 to generate program information, using the response message of FIG. 10. As described above, the generative AI system 50 is notified of the application information such as the item name and the data format. The generative AI system 50 generates the program information using the application information such as the item name and the data format.

FIG. 11 is an example of a request message used by the information process system to call the first API 31 published by the generative AI system 50. The request message includes role 651, 653 and content 652, 654. The role 651, 653 indicates a speaker, and includes a user, an assistant (AI of the generative AI system 50), and a system (instructing settings of the AI assistant). The content 652, 654 indicates the conversation contents, and may be written in the natural language. The content 652 of “system” indicates “Please help to add JavaScript® to application below”. The content 652 may further include detailed notes regarding the program code. The content 652 includes the item name acquired from the application service 40 as illustrated in FIG. 10.

The content 652 is generated by the chat controller 23 in response to the pressing of the “customize application” button 623 illustrated in FIG. 6. In the case where the user inputs to the user terminal 10 a chat message indicating that the user wants to generate a program code, the content 652 is not necessary.

The content 654 of “user” is “Please always designate one person in charge”. The content 654 is the chat message 632 that the user has input on the chat screen 630 of FIG. 7.

The request message of FIG. 11 includes the function specification setting 655. “function” indicates the function specification setting 655, and the function specification setting 655 has a name 656. name 656 is the name of the function (add_actions). The generative AI system 50 calls the function by specifying this name.

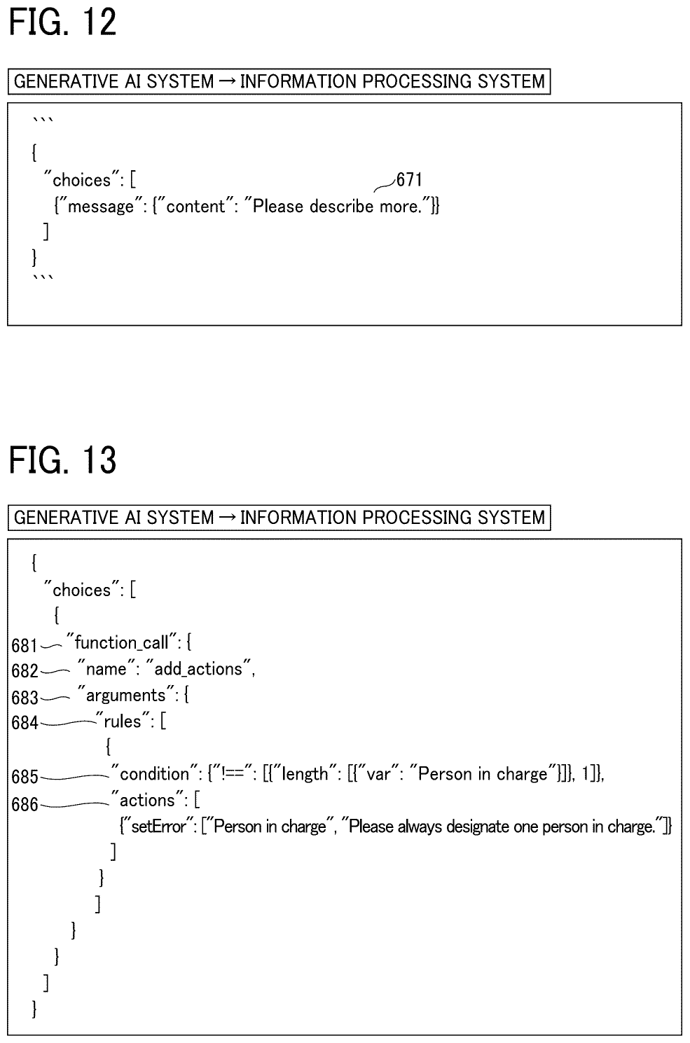

With the function specification setting 655, the information processing system 20 instructs the generative AI system 50, so that the generative AI system 50 requests the information processing system 20 to call the function defined as illustrated in FIG. 11. FIG. 12 is an example of a response message that the generative AI system 50 transmits to the information processing system 20 in response to the request message of FIG. 11. The response message of FIG. 12 does not include a function call request (function call), and is not a response message expected by the chat controller 23. In such a case, the information processing system 20 transmits the message included in the response message to the user terminal 10. In the example of FIG. 12, the response message 671 indicates “Please describe more”. The user terminal 10 receives the user input of more specific information for customizing the application, and transmits the input information to the information processing system 20. The chat controller 23 transmits a request message including specific information to the generative AI system 50. Accordingly, the chat controller 23 obtains a response message including a function call request (function call).

FIG. 13 is an example of a response message that the generative AI system 50 transmits to the information processing system 20 in response to the request message of FIG. 11. The response message of FIG. 13 includes a function call request 681 (function call). In the case where the function call of FIG. 13 is included in the response message, the chat controller 23 detects the function call, and the program generator 26 generates the program code. The customizer 25 requests the application service 40 to add the program code. The application service 40 is a low-code or no-code platform. As described above, the information process system 20 adds the program code to the application of the application service 40, while the user makes conversations with the generative AI system 50 in the natural language by calling the second API 32 published by the application service 40 and the first API 31 published by the generative AI system 50.

The function call request 681 of the response message corresponds to a request for adding a program code. The function call request 681 includes name 682 and arguments 683. name 682 is the name of the function defined in the function specification setting 655. The generative AI system 50 requests the information processing system 20 to call the function having this name. arguments 683 is a return value, and is defined in the function specification setting 655. In FIG. 13, rules 684 and subsequent values are return values. The rules 684 correspond to the program information.

“rules” 684 includes “condition” 685 and “actions” 686. “condition” 685 describes the conditional part of the program code in JsonLogic. The “actions” 686 is a process executed when the conditional part is satisfied. Since “rules” 684 is described in JsonLogic, the information processing system 20 can analyze “rules” 684 by using the existing library. “condition” 685 indicates the condition where the number of persons in charge is not one. “actions” 686 indicates that an error message “Please always designate one person in charge” is displayed in association with the item of the name of the person in charge. The program generator 26 analyzes the “rules” 684 and generates the program code. At least one of “condition” 685 and “actions” 686 included in the “rules” 684 is an example of a parameter requested from the generative AI system 50.

“rules” 684 does not need to be described in the JSON format according to JsonLogic. JsonLogic always takes the form {“operator”: [“values”.]}. For example, the program generator 26 converts {“+”: [1, 2, 3]} into JavaScript of 1+2+3. If the operator is not an operator, for example, if the operator is {“f”: [1, 2, 3]}, the operator is converted into JavaScript f (1, 2, 3). It is assumed that the value of the existing record registered in the application service 40 can be referred to by {“var”: “item name”} using var.

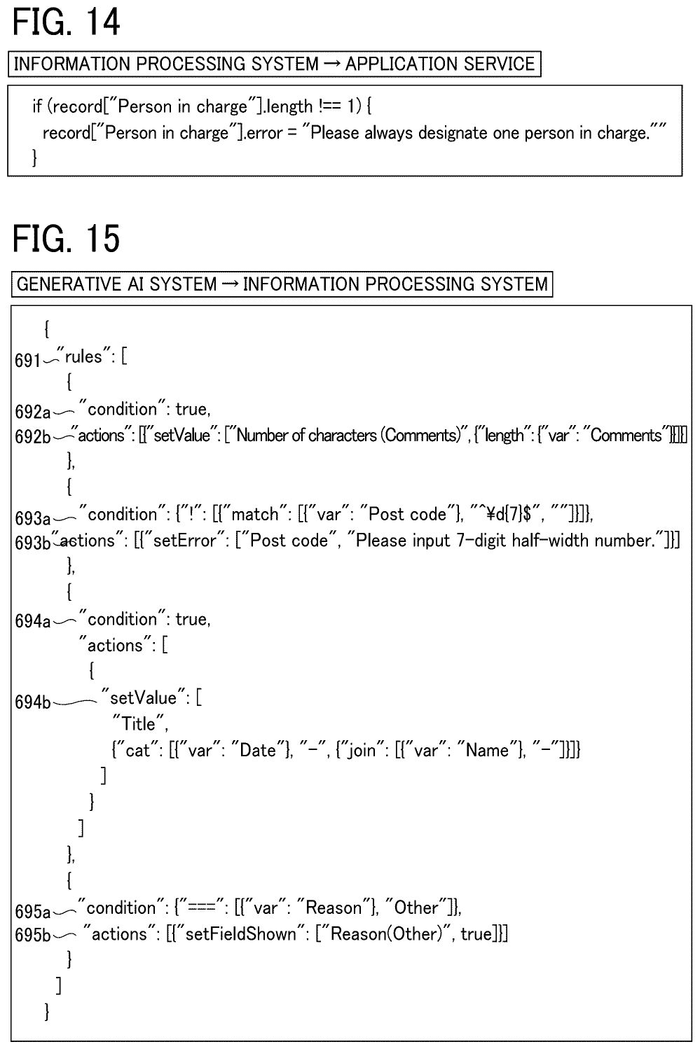

FIG. 14 illustrates an example of a program code generated by the program generator 26 based on the function call request 681 of FIG. 13. The program code of FIG. 14 is written in JavaScript®. This program code indicates that, when the number of pieces of data of the name of the person in charge is not one, an error message “Please always designate one person in charge” is displayed in the item of the name of the person in charge of the corresponding record.

As described above, the generative AI system 50 generates the program code by the function call request 681 (function call), and requests the information processing system 20 to call a function for adding the generated program code.

The chat controller 23 of the information processing system 20 analyzes the function call request 681 included in the response message of FIG. 13, generates the program code, and determines to add the program code to the application service 40 (execution of the function). The chat controller 23 notifies the program generator 26 that the function call request 681 has been received. The program generator 26 analyzes the rules 684 to generate the program code, and notifies the customizer 25 of the program code. The customizer 25 calls the second API 32 published by the application service 40 and requests the application service 40 to add the generated program code.

The information processing system 20 uses, for example, the API of the application service 40. Examples of the API include an API for adding a program code published by the application service 40. As described above, the program code is added to the customer management application of the application service 40 by the request message and the response message.

### Example of Complicated Program Information and Program Code

An example of generating the program information and the program code, which are slightly more complicated than the program information of FIG. 13 and the program code of FIG. 14, is described below.

FIG. 15 is an example of a response message that the generative AI system 50 transmits to the information processing system 20 in response to the request message of FIG. 11. FIG. 15 illustrates the function_call after rules 691.

condition 692a describes the conditional part of the program code in JsonLogic. This conditional part is not a substantial condition as it indicates the condition when the user has input information. actions 692b is a process executed when the conditional part is satisfied, and indicates that the number of characters in the “comment” field is set in the “number of characters (comment)” field. The chat message of the user, which is a source for the generative AI system 50 to generate condition 692a and actions 692b, may be, for example, “Set the number of characters in the comment field to the number of characters (comment) field”. At least one of condition 692a and actions 692b is an example of a parameter requested from the generative AI system 50.

condition 693a describes the conditional part of the program code in Json Logic. This conditional part indicates a condition that the “post code” field does not match the regular expression “¥d {7} $”. actions 693b is a process executed when the conditional part is satisfied, and indicates setting of an error (display “Please input 7-digit half-width number”). The chat message of the user, which is a source for the generative AI system 50 to generate condition 693a and actions 693b, may be, for example, “If the post code is not a 7-digit regular expression, make an error”.

condition 694a describes the conditional part of the program code in JsonLogic. This conditional part is not a substantial condition as it indicates the condition when the user has input information. actions 694b is a process executed when the conditional part is satisfied, and indicates that a character string obtained by combining “date” and “person in charge” is set in “title”. The chat message of the user, which is a source for the generative AI system 50 to generate condition 694a and actions 694b, may be, for example, “Please include date and person in charge in title”.

condition 695a describes the conditional part of the program code in JsonLogic. This conditional part indicates a condition that “reason” is “other”. actions 695b is a process executed when the conditional part is satisfied, and indicates that a field “reason (other)” is displayed. The chat message of the user, which is a source for the generative AI system 50 to generate condition 695a and actions 695b, may be, for example, “If the reason is other, create a field called reason (other)”.

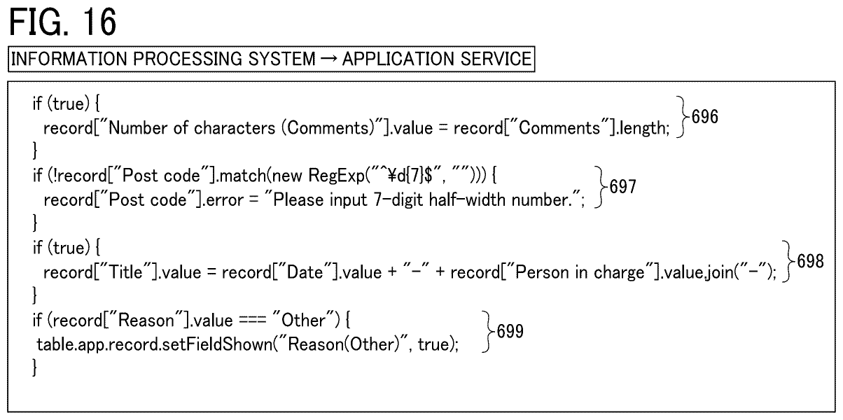

FIG. 16 illustrates an example of a program code generated by the program generator 26 based on the rules 691 illustrated in FIG. 15. The program code of FIG. 16 is written in JavaScript®. The description 696 is generated based on condition 692a and actions 692b. The description 697 is generated based on condition 693a and actions 693b. The description 698 is generated based on condition 694a and actions 694b. The description 699 is generated based on condition 695a and actions 695b.

### After Addition of Program Code

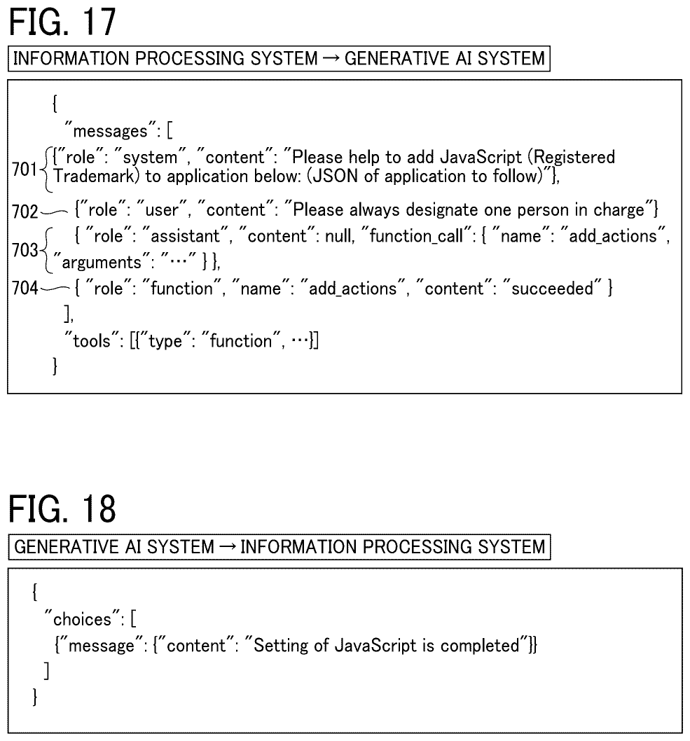

FIG. 17 is an example of a request message used by the information process system to call the first API 31 published by the generative AI system 50, after the program code is added. When the information process system 20 adds the program code to the application service 40, the information process system 20 adds “setting is completed” to the conversation history and calls the first API 31.

The conversation history 701 includes role 651, 653 and content 652, 654 illustrated in FIG. 11. The conversation history 702 is a chat message illustrated in content 654. The conversation history 703 indicates that the generative AI system 50 has already requested the function call (the contents of FIG. 13). The description 704 is a description for the information processing system 20 to transmit the execution result of the function to the generative AI system 50. The chat controller 23 sets the executed function and an indication of success or failure of the execution of the function (succeeded in the drawing) in the description 704.

FIG. 18 illustrates a response message returned by the generative AI system 50 in response to the request message of FIG. 17. The generative AI system 50 is expected to return a result as illustrated in FIG. 18. The information processing system 20 transmits a message “Setting of JavaScript is completed” to the user terminal 10 as a response message.

As illustrated in FIGS. 17 and 18, the chat controller 23 generates a request message including the conversation history, calls the first API 31 of the generative AI system 50, and receives a response message. By repeating this process, the information processing system 20 can add the program code to the application service 40 through the interaction with the generative AI system 50. In other words, the user can add the program code to any application by simply entering chat messages.

### Operations or Processes

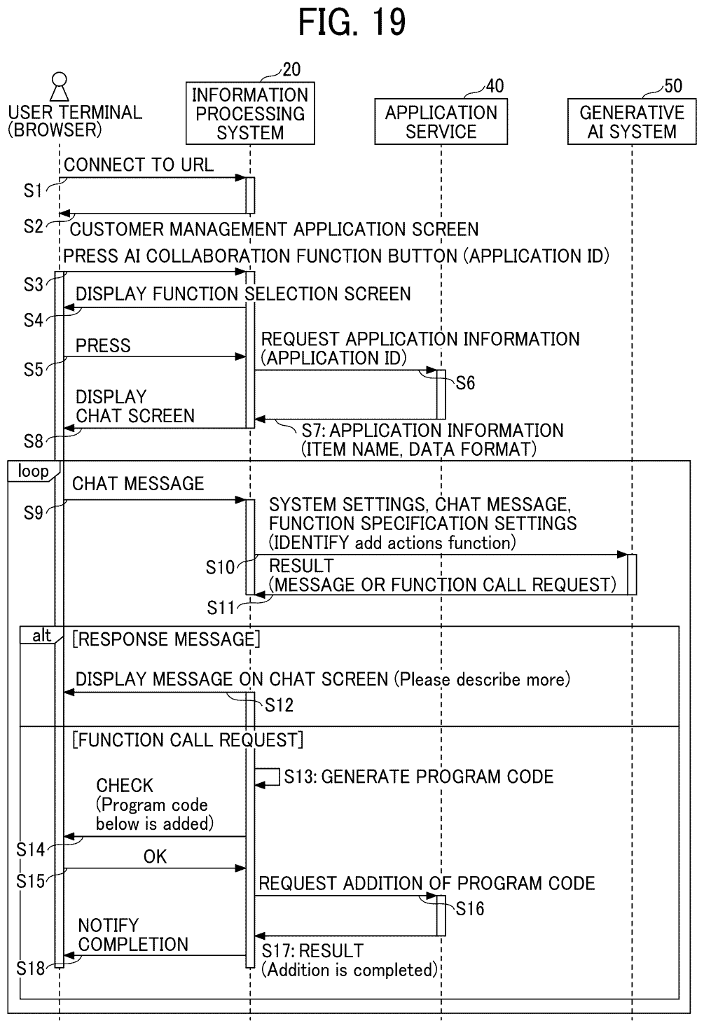

FIG. 19 is a sequence diagram illustrating an example process of assisting addition of the program code, performed by the information processing system 20 in cooperation with the application service 40 and the generative AI system 50. Steps S9 to S18 are repeatedly executed in the main flow, and the operation proceeds either to step S12 or S13.

At S1, the communication unit 11 of the user terminal 10 connects to the uniform resource locator (URL) of the information process system 20. The URL may be input at the user terminal 10, for example, by a direct input by the user or receiving a user selection of a shortcut. The communication unit 11 of the user terminal 10 generates a HTTP request including the URL of the customer management application, and transmits the HTTP request to the information processing system 20.

When the communication unit 21 of the information process system 20 receives the HTTP request from the user terminal 10, at S2, the screen generator 22 generates the screen information of the customer management application screen. The communication unit 21 transmits an HTTP response including the screen information of the customer management application screen to the user terminal 10 as a response to the HTTP request. Accordingly, the customer management application screen of FIG. 5 is displayed at the user terminal 10.

The user operates the user terminal 10 to press the AI collaboration function button 616. At S3, the operation receiver 13 receives the pressing by the user. With the pressing, an application ID of the application is also specified. The communication unit 11 of the user terminal 10 transmits a notification indicating that the AI collaboration function button 616 has been pressed, and the application ID, to the information processing system 20.

In response to the communication unit 21 of the information process system 20 receiving the notification that the AI collaboration function button 616 has been pressed and the application ID, the screen generator 22 generates a function selection screen at S4. The communication unit 21 transmits the screen information of the function selection screen to the user terminal 10.

When the communication unit 11 of the user terminal 10 receives the screen information of the function selection screen, the display controller 12 displays the function selection screen 620 (see FIG. 6). The user operates the user terminal 10 to press the “customize application” button 623 of the application. At S5, the operation receiver 13 receives the pressing. The communication unit 11 of the user terminal 10 transmits the notification indicating that the “customize application” button 623 of the application has been pressed to the information processing system 20.

The communication unit 21 of the information processing system 20 receives the notification that the “customize application” button 623 of the application has been pressed. In response to the pressing of the “customize application” button 623 of the application, the processing controller 28 causes the customizer 25 to acquire the application information at S6. The customizer 25 calls the second API 32. The customizer 25 calls the second API 32 using a request message for requesting acquisition of the application information together with the application ID.

At S7, the application service 40 returns the application information (for example, item name and data format) of the application identified with the application ID to the information process system 20 via the second API 32 (see FIG. 10). The customizer 25 obtains the application information (for example, item name and data format) from the application service 40.

The screen generator 22 of the information processing system 20 obtains the application information. At S8, the screen generator 22 transmits screen information of the chat screen to the user terminal 10. The user can instruct generation of the program code on the chat screen.

When the communication unit 11 of the user terminal 10 receives the screen information of the chat screen, the display controller 12 displays the chat screen 630 (see FIG. 7). The user operates the user terminal 10 to input a chat message, such as a chat message 632. The chat message 632 is, for example, “Please always designate one person in charge”. At S9, the operation receiver 13 receives the input. The communication unit 11 of the user terminal 10 generates a request message including the chat message and transmits the generated request message to the information processing system 20. The communication unit 11 of the user terminal 10 transmits the generated request message as, for example, an HTTP request. The communication unit 11 of the user terminal 10 may generate a request message including a conversation history. The conversation history may be stored by the information processing system 20, for example, in a memory provided for the information processing system 20. When the information processing system 20 keeps storing the conversation history, the communication unit 11 of the user terminal 10 may not include the conversation history in the request message.

At S10, the communication unit 21 of the information process system 20 receives the request message. The processing controller 28 of the information processing system 20 determines to add the program code based on the notification indicating that the “customize application” button 623 has been pressed or by analyzing the chat message 632. The generative AI system 50 may be used to analyze the chat message 632. In this case, the chat controller 23 transmits the chat message 632 to the generative AI system 50 and acquires a request or intention of the user to add the program code.

The processing controller 28 passes the chat message to the chat controller 23. The chat controller 23 generates a request message including the system settings (setting information), the chat message, and the function specification settings, and transmits the generated request message to the generative AI system 50 by calling the first API 31 (see FIG. 11).

At S11, the generative AI system 50 returns a response message, which is a response message (regular message without a function call request) or a response message including a function call request, to the information process system 20 (see FIGS. 12 and 13). The chat controller 23 receives the response message from the generative AI system 50. The response message that is received may be the response message illustrated in FIG. 12 or the function call request illustrated in FIG. 13. In the case where the response message is the response message (regular message), the operation proceeds to S12. In the case where the response message includes the function call request, the operation proceeds to S13.

When the chat controller 23 receives the regular response message, the communication unit 21 of the information process system 20 transmits the response message to the user terminal 10 at S12. For example, the response message is “Please describe more”.

When the chat controller 23 receives the function call request, at S13, the chat controller 23 analyzes the function and determines that the addition of the program code to the application service 40 is requested (the customization of the application). Since the function for adding the program code is specified in the function specification settings of S10, the chat controller 23 can easily determine that the request is the request for adding the program code based on the name (name 682) of the function included in the function call request. The chat controller 23 acquires the program information (arguments 683) included in the function call request. The chat controller 23 passes arguments 683 to the program generator 26. The program generator 26 analyzes the program information and generate the program code (see FIG. 14).

As described above, in another example, the generative AI system 50 may also generate the program code. Since the generative AI system 50 can create the program information in JsonLogic, the generative AI system 50 can also create the program code. The generative AI system 50 may generate the program code as long as the program code is a program code that does not destroy data of a customer of the application service 40. The program code generated by the information processing system 20 is not likely to contain any defect.

In order to receive the confirmation from the user, the chat controller 23 causes the screen generator 22 to generate a confirmation message (program code below is added) at S14. The communication unit 21 transmits the confirmation message to the user terminal 10. When the communication unit 11 of the user terminal 10 receives the confirmation message, the display controller 12 displays the chat screen 630 (FIG. 8). The chat screen 630 displays the message 633 “The program code below is added”, the program code 634a, the explanatory text 634b, the OK button 635, and the cancel button 636. The user operates the user terminal 10 to press the OK button 635 or the cancel button 636. In the example of FIG. 19, it is assumed that the OK button 635 is pressed. At S15, the operation receiver 13 receives the pressing.

The communication unit 11 of the user terminal 10 transmits the notification indicating that the OK button 635 has been pressed to the information processing system 20. At S16, the communication unit 21 of the information process system 20 receives the notification indicating that the OK button 635 is pressed. Since the OK button 635 is pressed, the processing controller 28 of the information processing system 20 determines to cause the customizer 25 to register the program code. The customizer 25 calls the second API 32 to transmit a request message for adding the program code to the application service 40. In other words, the customizer 25 causes execution of the function requested to be called from the generative AI system 50 by transmitting the request message. In this example, the customizer 25 adds the program code. The customizer 25 calls the one or more APIs described above. For example, the API for adding the program code published by the application service 40 may be called.

The customizer 25 causes the request message to include the program code and the application ID, and requests the addition of the program code. The request message may vary depending on the application service 40.

As described above, the customizer 25 transmits the request (function_call), which is transmitted by the generative AI system 50 based on the chat message, the item name, and the function specification settings, to the chat controller 23. The request includes the program information generated by the generative AI system 50 based on, for example, the chat message and the item name. The chat controller 23 generates the program code from the program information included in the received request and add the program code to the application.

At S17, the customizer 25 receives the response message from the application service 40. The result included in the response message indicates, for example, completion of the addition of the program code. If the addition of the program code fails, the message indicating that the addition of the program code fails is transmitted to the user terminal 10. In order to keep the conversation, the chat controller 23 transmits, to the generative AI system 50, a request message including the execution result (completion of addition of the program code) of the function requested by the function call request. The operation then proceeds to S10 (see FIG. 17). Accordingly, the chat controller 23 receives the response message indicating that the addition of the program code is completed from the generative AI system 50 (see FIG. 18).

When the addition of the program code is successful, at S18, the communication unit 21 of the information process system 20 transmits, for example, a message “Addition is completed” to the user terminal 10 (see FIG. 9).

The operation of FIG. 19 is thus completed, and the operation returns to S9 as necessary, for example, when the user wants to add more program code. For example, the user may input a chat message for adding another program code.

With the addition of the program code, if the user registers the information on the customer in the customer management application but does not set the person in charge or sets two or more persons in charge, the customer management application will display an error message.

In the information processing system 20, the user at the user terminal 10 only inputs the contents of customization of the application in the natural language. The information processing system 20 generates the program code used in the application using the generative AI system 50, and add the program code to the application service 40.

In the above-described operation of FIG. 19, in response to receiving the chat message at S9, the information processing system 20 transmits the chat message, the system settings (setting information), and the function specification settings, to the generative AI system 50 at S10. In other words, the system settings and the function specification settings are transmitted with the chat message, in response to receiving the chat message. Alternatively, the information processing system 20 may transmit, to the generative AI system 50, the system settings (setting information) and the function specification settings before receiving the chat message from the user terminal 10, for example, when the chat screen is displayed. In response to receiving the chat message, the information processing system 20 transmits the chat message to the generative AI system 50. Since the system settings and the function specification settings can be kept at the generative AI system, the system settings and the function specification settings do not have to be transmitted.

### Second Embodiment

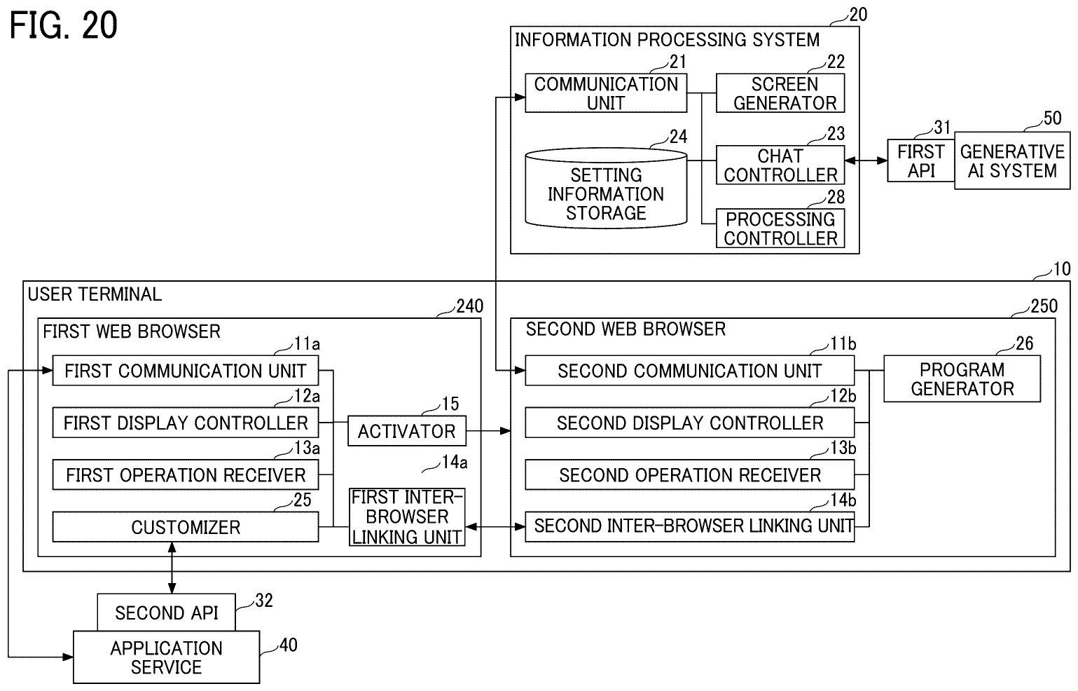

Referring to FIGS. 20 to 22, the second embodiment is described.

The second embodiment relates to authentication of the information process system performed when the information processing system 20 uses the second API 32 published by the application service 40.

In order for the information processing system 20 to call the second API 32, the information processing system 20 is to be authenticated by the application service 40. When the information processing system 20 performing the processes in the sequence diagram of FIG. 19 operates in the same domain as that of the application service 40, the authentication information of the application service 40 is transmitted from the web browser operating on the user terminal 10 to the information processing system 20. For example, the authentication information may be previously included in the cookie. Based on the authentication using the authentication information, the information process system 20 can call the second API 32 published by the application service 40. When the low-code or no-code platform (application service 40) and the information processing system 20 are developed by the same organization, it is easy to make the system such that the application service 40 and the information processing system 20 operate in the same domain.

When the information processing system 20 and the application service 40 operate in different domains, there may be an issue related to the authentication process. The potential issue is described with reference to FIG. 6. It is assumed that the user can use the application or develop the application from the customer management application screen 610.

For example, the customer management application screen 610 provided by the application service 40 operates as follows. First, the customer management application screen 610 is executed by the web browser (first web application). When the user presses the AI collaboration function button 616 on the customer management application screen 610, a pop-up window of the function selection screen 620 is displayed to allow the user to communicate with the information processing system 20. It is assumed that the function selection screen 620 is opened by another web browser, which is referred to as the second web application. In this case, the application service 40 and the information processing system 20 operate in different domains. Thus, the user terminal 10 cannot transmit the authentication information of the application service 40 to the information processing system 20. The information process system 20 cannot call the second API 32 published by the application service 40. Since the function selection screen 620 displayed in the pop-up window operates in a different domain from that of the customer management application screen 610, the function selection screen 620 displayed by the second web application in the pop-up window cannot access the cookie of the application service 40.

In view of this, the function selection screen 620 (second web application) displayed in the pop-up window requests the customer management application screen 610 (first web application) to call the second API 32 published by the application service 40.

### Functions

FIG. 20 is a diagram illustrating an example of a functional configuration of the information processing system 20 and a user terminal 10 according to the second embodiment. The functions of the developer terminal 60 are substantially the same as the functions of the developer terminal 60 illustrated in FIG. 4 of the first embodiment, and the description thereof is omitted. In FIG. 20, differences from the functional configuration of FIG. 4 are described.

### User Terminal

The user terminal 10 executes a first web browser 240 and a second web browser 250. The first web browser 240 and the second web browser 250 may be separate applications, or may be separate tabs (separate web applications) displayed by a tab browser.

The first web browser 240 includes a first communication unit 11a, a first display controller 12a, a first operation receiver 13a, a customizer 25, an activator 15, and a first inter-browser linking unit 14a. These functional units are functions or means implemented by the CPU 501 illustrated in FIG. 3 executing a script included in the web application acquired by the user terminal 10 from the application service 40. The customizer 25 may be the same as the customizer 25 of FIG. 4.

The first communication unit 11a transmits and receives various kinds of information to and from the application service 40. The first communication unit 11a receives screen information such as the customer management application screen from the application service 40.

The first display controller 12a interprets the screen information such as a web application displayed by the first web browser 240 and displays the screen information on the display 506. The first operation receiver 13a receives various operations of the user on the web application displayed on the display 506.

The activator 15 activates the second web browser 250 in response to a user operation on the web application displayed by the first web browser 240. The web application displayed by the first web browser 240 includes the URL of the information processing system 20. The second web browser 250 connects to the URL of the information processing system 20.

The first inter-browser linking unit 14a transmits and receives information to and from a second inter-browser linking unit 14b of the second web browser 250. One user terminal 10 can simultaneously execute a plurality of web browsers. The first inter-browser linking unit 14a may notify the second inter-browser linking unit 14b of various information. Similarly, the second inter-browser linking unit 14b may notify the first inter-browser linking unit 14a of various information. With the first inter-browser linking unit 14a and the second inter-browser linking unit 14b, even when only the first web browser 240 holds authentication information for a specific web site (for example, the application service 40), the second web browser 250 can communicate with the specific web site in cooperation with the first web browser 240. The first web browser 240 communicates with the application service 40, and the second web browser 250 communicates with the generative AI system 50 via the information processing system 20. The second web browser 250 transmits the response message from the generative AI system 50 to the first web browser 240 by using the second inter-browser linking unit 14b. The functions of the first inter-browser linking unit 14a and the second inter-browser linking unit 14b are described in the scripts transmitted from the application service 40 and the information process system 20, respectively.

The second web browser 250 includes a second communication unit 11b, a second display controller 12b, a second operation receiver 13b, the second inter-browser linking unit 14b, and a program generator 26. These functional units are functions or means implemented by the CPU 501 illustrated in FIG. 3 executing a script included in the web application acquired by the user terminal 10 from the information processing system 20. The program generator 26 may be the program generator illustrated in FIG. 4. As described above, the program generator 26 may be included in the information processing system 20 in the present embodiment.

The second communication unit 11b transmits and receives various types of information to and from the information processing system 20. The first communication unit 11a receives the screen information of the function selection screen 620 and the chat screen 630 from the information process system 20. The second communication unit 11b transmits the chat message to the information process system 20 or receives the function call request from the information process system 20.

The second display controller 12b interprets the screen information such as the web application displayed by the second web browser 250 and displays the screen information on the display 506. The second operation receiver 13b receives various operations of the user on the web application displayed on the display 506.

As described above, the second inter-browser linking unit 14b has substantially the same function as the function of the first inter-browser linking unit 14a. When the second inter-browser linking unit 14b receives the function call request (request to add the program code) from the information process system 20, the second inter-browser linking unit 14a transmits the function call request to the first inter-browser linking unit 14a.

### Information Processing System

The information processing system 20 includes the communication unit 21, the screen generator 22, the chat controller 23, the setting information storage 24, and the processing controller 28. The functions of these units may be substantially the same as the functions illustrated in FIG. 4.

### Operations or Processes

FIGS. 21 and 22 are a sequence diagram illustrating example operation of adding the program code to the application service 40 by the information processing system 20 using linking of the two web browsers of the user terminal 10. In FIGS. 21 and 22, differences from the operation of FIG. 19 are focused.

At S21, the user enters the URL of the application service 40 at the user terminal 10. The web browser connected to the application service 40 is referred to as the first web browser 240.

At S22, the first communication unit 11a of the first web browser 240 connects to the URL of the application service 40. The user instructs the user terminal 10 to connect to the URL of the customer management application screen 610. The first communication unit 11a of the first web browser 240 transmits an HTTP request including the URL of the customer management application screen 610 to the application service 40.

When the application service 40 receives the HTTP request from the user terminal 10, at S23, the communication unit 21 transmits the screen information of the customer management application screen 610 to the user terminal 10. The screen information, which may be in HTML, JavaScript, or CSS, includes, for example, a script for activating the second web browser 250, a script for adding the program code, and the URL of the function selection screen 620.

The first communication unit 11a of the first web browser 240 receives the screen information of the customer management application screen 610. At S24, the first display controller 12a displays the customer management application screen 610 (see FIG. 5).

The user presses the AI collaboration function button 616 on the customer management application screen 610. At S25, the operation receiver 13a receives the pressing by the user.

At S26, the activator 15 activates the second web browser 250. The first inter-browser linking unit 14a notifies the second web browser 250 of the application ID included in the customer management application screen 610 and the URL (an example of address information) of the function selection screen 620. The second web browser 250 is displayed in a pop-up window. More specifically, the second web browser 250 is activated by a script included in the screen information of the customer management application screen 610.

At S27, the second communication unit 11b of the second web browser 250 requests the information process system 20 to provide the function selection screen 620 by using the URL of the function selection screen 620 notified from the first web browser 240.

In response to the request, at S28, the screen generator 22 of the information process system 20 generates the function selection screen 620. The communication unit 21 transmits the screen information of the function selection screen 620 to the second web browser 250. At S29, the second communication unit 11b of the user terminal 10 receives the screen information of the function selection screen 620. The second display controller 12b displays the function selection screen 620 based on the screen information (see FIG. 6).

The user operates the user terminal 10 to press the “customize application” button 623 on the function selection screen 620. At S30, the second operation receiver 13b receives the pressing of the “customize application” button 623.

In response to the pressing of the “customize application” button 623, at S31, the second inter-browser linking unit 14b of the second web browser 250 specifies the application ID and requests the first web browser 240 to acquire the application information of the application services 40. Any technique may be used for linking between browsers such as through communicating messages.

At S32, the customizer 25 of the first web browser 240 generates a request message for calling the second API 32 of the application service 40. The request message requests the application service 40 to acquire application information by specifying the application ID.

At S33, the application service 40 causes a response message to include the application information, such as the item name and the data format, of the application identified by the application ID, and transmits the response message to the first web browser 240. The customizer 25 receives the response message (see FIG. 10).

At S34, the first inter-browser linking unit 14a of the first web browser 240 transmits the application information to the second web browser 250.

When the second inter-browser linking unit 14b of the second web browser 250 receives the application information, at S35, the second display controller 12b switches the display from the function selection screen 620 to the chat screen 630. The chat screen 630 is transmitted from the information process system 20, for example, at S28. The second display controller 12b displays the chat screen 630 (see FIG. 7).

At S36 of FIG. 22, the user inputs a chat message 632 such as “Please always designate one person in charge” to the chat screen 630.

The subsequent processes of S37 to S39 are performed in a substantially similar manner as the processes of S9 to S11 of FIG. 19. The chat controller 23 transmits the request message of FIG. 11 and receives the response message of FIG. 12 or 13. At S37, the second communication unit 11b transmits the application information to the information process system 20.

At S40, the communication unit 21 of the information process system 20 receives a response message (regular message) or a response message including a function call request from the generative AI system 50.

In the case of the response message, the operation proceeds to S41. In the case of the function call request, the operation proceeds to S42.

When the second web browser 250 receives the response message from the generative AI system 50 at S40, at S41, the second display controller 12b of the second web browser 250 displays the response message (for example, please describe more).

When the second web browser 250 receives the function call request from the generative AI system 50 at S40, at S42, the program generator 26 of the second web browser 250 analyzes the program information and generates the program code.

The program code may be generated by the information processing system 20.

The processes performed at S43 and S44 may be substantially the same as the processes performed at S14 and S15 of FIG. 19. The user terminal 10 displays the chat screen 630 of FIG. 8.

When the OK button 635 is pressed on the chat screen 630 of FIG. 8, at S45, the second inter-browser linking unit 14b of the second web browser 250 requests the first web browser 240 to add the program code to the application service 40 by specifying the application ID. The method of linking between the browsers may be performed in a substantially similar manner as described above referring to S31.

At S46, the customizer 25 of the first web browser 240 calls the second API 32 to add the program code to the application service 40 by specifying the application ID.

At S47, the application service 40 transmits the result of the addition of the program code to the first web browser 240. The result indicates that, for example, the addition is completed. If the failure occurs, the result indicating that the failure occurs is transmitted to the first web browser 240.

At S48, the first inter-browser linking unit 14a of the first web browser 240 transmits the result indicating the addition of the program code to the second web browser 250. In order to keep the conversation, the second web browser 250 transmits the execution result of the function (completion of the addition of the program code) to the information processing system 20. The chat controller 23 transmits, to the generative AI system 50, a request message including the execution result (completion of addition of the program code) of the function requested by the function call request. The operation then proceeds to S38 (see FIG. 17). Accordingly, the chat controller 23 receives the response message indicating that the addition of the program code is completed from the generative AI system 50 (see FIG. 18). When the addition is completed, at S49, the second display controller 12b of the second web browser 250 displays a message such as “addition is completed” on the chat screen 630 (see FIG. 9).

As described above, the information processing system 20 of the second embodiment can add the program code to the application even when the application service 40 and the information processing system 20 provide services from web sites of different domains.

The above-described embodiments are illustrative and do not limit the present disclosure. Thus, numerous additional modifications and variations are possible in light of the above teachings within the scope of the present disclosure. Any one of the above-described operations may be performed in various other ways, for example, in an order different from the one described above.

For example, in the above-described embodiments, the generative AI system 50 generates the program information. Alternatively, the generative AI system 50 may directly generate the program code.

In the above-described embodiments, the information processing system 20 adds the program code to the application service 40, which is the web application. Alternatively, the program code to be added may be the program code of the native application. For example, assuming that the application is spreadsheet software, the information processing system 20 generates the program code of VISUAL BASIC (registered trademark) for controlling the spreadsheet software, and adds the program code to the spreadsheet software.

In the above-described embodiments, JavaScript is used as an example of the program language of the program code. Alternatively, the program language may be any language such as HTML (CSS), Personal Home Page (PHP®), Ruby, Python®, Go, Swift®, C #, Kotlin®, Java®, R, C, Objective-C®, or Julia®.

Further, the application itself may execute the functions of the information processing system 20 described in the above-described embodiments. If the application executes the functions, the application receives the application ID from the user terminal 10. The information processing system 20 does not need to transmit the application ID to the application service 40.

In the above-described embodiments, the cases where the information processing system 20 receives the function call request from the generative AI system 50 has been described. Alternatively, the information processing system 20 may receive the call request of the Web-API itself from the generative AI system 50. In other words, the function and the API may not be strictly distinguished from each other.

The apparatuses or devices described in one or more embodiments are just one example of plural computing environments that implement the one or more embodiments disclosed herein. In some embodiments, the information processing system 20 includes multiple computing devices, such as a server cluster. The multiple computing devices are configured to communicate with each other over any type of communication link, including a network, a shared memory, etc. to collectively perform the processes disclosed herein.

Further, a plurality of components in the information processing system 20 can be configured to share the processing steps disclosed in the embodiments described above, for example, the processing steps illustrated in FIG. 19, in various combinations. For example, a process executed by a predetermined unit may be executed by a plurality of information processing apparatuses included in the information processing system 20. The information processing system 20 may be integrated into one server device or may be divided into a plurality of devices.

In the block diagram such as FIG. 4, the functional units are divided into blocks in accordance with main functions of the information processing system 20, in order to facilitate understanding of the operation performed by the information processing system 20. No limitation to a scope of the present disclosure is intended by how the processes are divided or by the name of the processes. The processes of the information processing system 20 may be divided into more units of process in accordance with the content of the process. Alternatively, one unit of process may be a group of divided processes.

A configuration example in which the application service 40 and the information processing system 20 are combined into one system is described below. The following describes the example case in which the information processing system 20 has the functions of the application service 40. Alternatively, the application service 40 may include the functions of the information processing system 20.

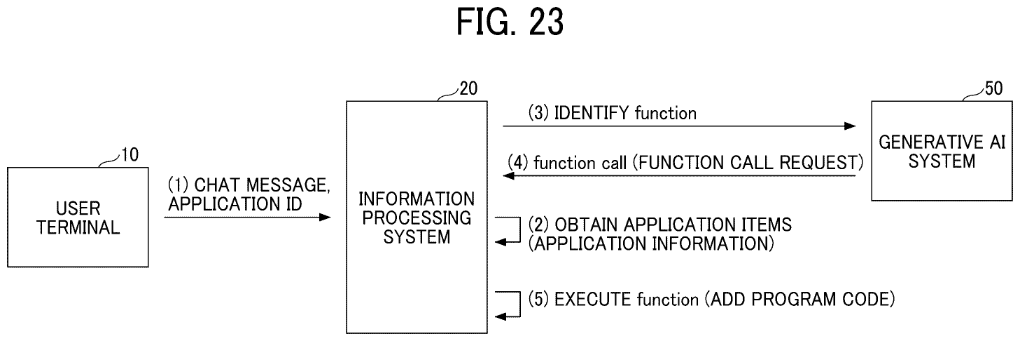

FIG. 23 is a diagram illustrating example processes performed so that the information processing system 20 generates the program code for the chat message input by the user.

The process (1) may be performed in a substantially similar manner as described above for the process (1) of FIG. 1.

At (2), the user terminal 10 requests the information processing system 20 to customize the application identified with the application ID. To customize the application, the information on items included in the application, which are referred to as the application items, are required. The information processing system 20 obtains the application information such as information on the application items of the application identified with the application ID from the information processing system 20.

The processes (3) and (4) may be performed in a substantially similar manner as described above for the processes (3) and (4) of FIG. 1.

At (5), the information processing system 20 generates a program code for customization in response to the function call request included in the response message transmitted from the generative AI system 50, and generates the program code for customization. The information processing system 20 adds the program code to the application provided by the information processing system 20 in response to the function call request.

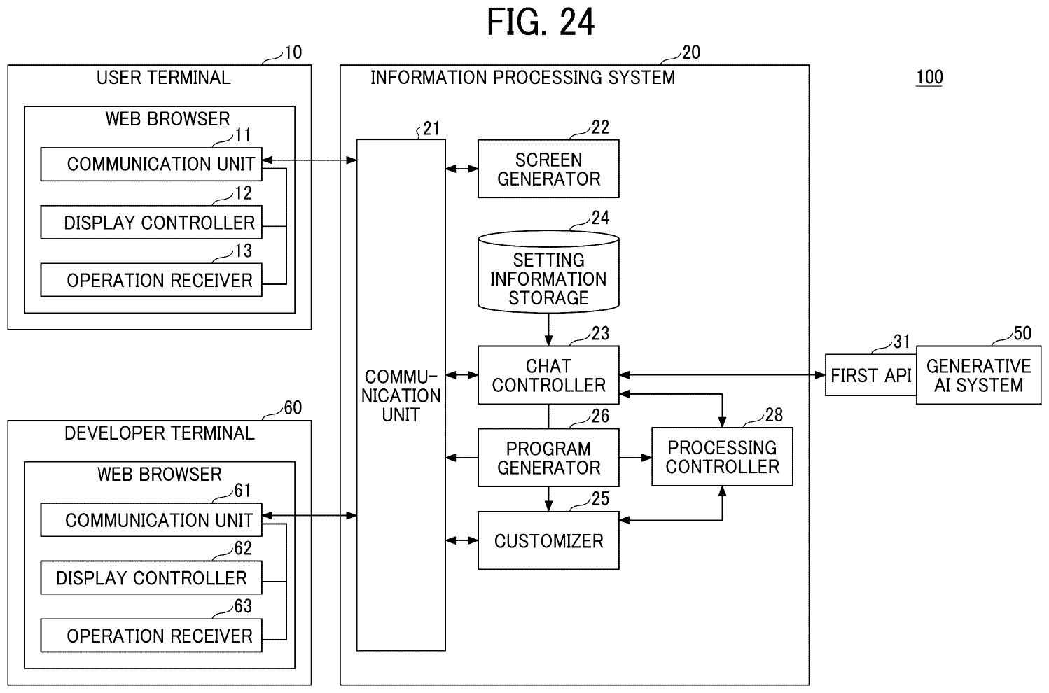

FIG. 24 is a diagram illustrating an example of a functional configuration of the information processing system 20, the user terminal 10, and the developer terminal 60 in a case where the application service 40 and the information processing system 20 are combined into one system. In the description referring to FIG. 24, for simplicity, the processes that are different from the processes of FIG. 5 are described. Since the information process system 20 and the application service 40 are combined into one system, the customizer 25 does not call the second API 32. The functions of the communication unit 21, the screen generator 22, the chat controller 23, the setting information storage 24, the program generator 26, and the processing controller 28 are substantially the same as the those illustrated in FIG. 5.

The customizer 25 of FIG. 24 functions by executing a predefined function. The customizer 25 customizes the application by adding the program code to the application in the information processing system 20 in response to the function call request from the generative AI system 50.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disk read only memory (CD-ROM) or digital versatile disc (DVD), and/or the memory of an FPGA or ASIC.

As described above, the generative AI system normally responds with a response message corresponding to a message such as a chat message input by the user. The response from the generative AI system depends on the generative AI system. Even when the same message is transmitted, the contents or the format (tone) in the response message may change, for example, depending on the timing when the messages are transmitted. For example, when the generative AI system is requested to generate the parameter for generating the program code for the first time, the generative AI system returns a response including the parameter written in a sentence. When the generative AI system is requested to generate the parameter for generating the program code for the second time, the generative AI system returns a response including the parameter written in bullet points.

In view of the above, if the information processing system is used to assist the user in developing the software application, the information processing system needs to be able to accurately interpret the response from the generative AI system and extract the parameter in whatever format the response is received in. It was technically difficult to create a mechanism to interpret all response formats.

This technical problem is now solved by using the function call. Specifically, the information processing system 20 transmits information for calling the function to the generative AI system 50. The generative AI system 50 generates the response based on the information for calling the function. Through these processes, the generative AI system 50 is caused to generate the response in a format requested by the information processing system 20.

Embodiments of the present invention provide significant improvements in computer capabilities and functionality. These improvements allow users to take advantage of computers that provide more efficient and robust interaction with tables that is a way to store and present information on information processing apparatuses. Further, embodiments of the present invention provide a better user experience through the use of a more efficient, powerful and robust user interface. Such a user interface provides a better interaction between a human and a machine.

According to Aspect 1, an information processing apparatus is capable of communicating with a terminal apparatus and a generative artificial intelligence (AI) system via a network. The information processing apparatus includes: a program generator that functions by executing a predefined function, and generates a program code related to a request based on a parameter included in the request; and a chat controller that, in response to receiving a chat message transmitted from the terminal apparatus, transmits the received chat message to the generative AI system. The chat controller transmits setting information related to generation of the program code and information for calling the function to the generative AI system at least once.

When the chat controller receives the request transmitted from the generative AI system based on the chat message transmitted to the generative AI system, the setting information transmitted to the generative AI system, and the information for calling the function transmitted to the generative AI system, the chat controller transmits a confirmation message for confirming whether the program code related to the request is to be generated to the terminal apparatus. In the case where a response to the confirmation message from the terminal apparatus indicates that the program code related to the request is to be generated, the program generator generates the program code related to the request based on the parameter included in the received request.

According to Aspect 2, an information processing apparatus is capable of communicating with a terminal apparatus and a generative artificial intelligence (AI) system via a network. The information processing apparatus includes: a program generator that functions by executing a predefined function, and generates a program code related to a request based on a parameter included in the request; and a chat controller that, in response to receiving a chat message transmitted from the terminal apparatus, transmits the received chat message to the generative AI system. The chat controller transmits setting information related to generation of the program code and information for calling the function to the generative AI system at least once. When the chat controller receives the request transmitted by the generative AI system based on the chat message transmitted to the generative AI system, the setting information transmitted to the generative AI system, and the information for calling the function transmitted to the generative AI system, the program generator generates the program code related to the request based on the parameter included in the received request.

According to Aspect 3, in the information processing apparatus of Aspect 1 or Aspect 2, the parameter is described in a JSON format. The program generator generates the program code based on the parameter described in the JSON format.

According to Aspect 4, in the information processing apparatus of any one of Aspect 1 to 3, when the chat controller receives from the generative AI system a response message to the chat message, the setting information, and the information for calling the function, each transmitted to the generative AI system, the chat controller transmits the response message to the terminal apparatus.

According to Aspect 5, in the information processing apparatus of Aspect 4, when the chat controller receives the request for adding the program code from the generative AI system, the program generator generates the program code based on the parameter included in the received request. When the chat controller receives from the generative AI system a response message to the chat message, the setting information, and the information for calling the function, instead of the request for adding the program code, the chat controller transmits the response message to the terminal apparatus.

According to Aspect 6, in the information processing apparatus of any one of Aspects 1 to 5, the information for calling the function includes specification settings of the function to be called by the generative AI system. A function call request for calling the function transmitted to the information processing apparatus by the generative AI system based on the function specification settings includes a request for adding the program code. The chat controller receives the request for adding the program code from the generative AI system.

According to Aspect 7, in the information processing apparatus of Aspect 3, the program code is added to the application. The information processing apparatus further includes a customizer that customizes the application by adding the program code to the application. The customizer acquires a name of the application item from the application. The chat controller transmits the acquired name of the application item to the generative AI system as information related to the application to which the program code is added, and receives the parameter related to the name of the application item from the generative AI system. The program generator generates the program code using the name of the application item based on the parameter related to the name of the application item. The customizer adds the program code generated by the program generator to the application.

According to Aspect 8, the information processing apparatus of Aspect 7 communicates with an application service that executes the application via a network. The customizer adds the program code generated by the program generator by calling an API published by the application service.

According to Aspect 9, in the information processing apparatus of Aspect 7 or Aspect 8, when the chat controller receives the request for adding the program code from the generative AI system, the chat controller transmits the program code to the terminal apparatus before the customizer adds the program code to the application. In response to receiving an instruction to add the program code from the user, the customizer adds the program code to the application to which the program code is to be registered.

According to Aspect 10, in the information processing apparatus of Aspect 7 or Aspect 8, when the chat controller receives the request for adding the program code from the generative AI system, the chat controller acquires an explanatory text of the program code together with the parameter from the generative AI system. Before the customizer adds the program code to the application, the chat controller transmits the explanatory text to the terminal apparatus. In response to receiving an instruction to add the program code from the user, the customizer adds the program code to the application to which the program code is to be registered.

According to Aspect 11, in the information processing apparatus of Aspect 8 or Aspect 9, the application is an application in which data is registered in a field included in a table. When the chat message transmitted from the terminal apparatus indicates that only one piece of data is to be set in one field, the program code determines whether only one piece of data is registered in one field, and displays an error when the number of pieces of data registered in one field is not one.

According to Aspect 12, in the information processing apparatus of Aspect 8 or Aspect 9, the application is an application in which data is registered in a field included in a table. When the chat message transmitted from the terminal apparatus indicates that the number of characters of data set in one field is set in the other field, the program code sets the number of characters of the data set in the one field in the other field.

According to Aspect 13, in the information processing apparatus of Aspect 8 or Aspect 9, the application is an application in which data is registered in a field included in a table. When the chat message transmitted from the terminal apparatus specifies a data format to be set in the field, the program code displays information indicating that the data in the field is to have a specific data format when the data in the field does not have the specific data format.

According to Aspect 14, a program generation system includes a terminal apparatus, and an information processing apparatus communicably connected with the terminal apparatus and a generative AI system via a network. The terminal apparatus includes terminal circuitry that executes a first web browser to implement a first communication unit that receives a first web application from an application service executing application, a first display controller that displays a screen of the first web application, and an activator that activates a second web browser using a script included in the first web application in response to operation to the first web application. The terminal circuitry further executes the second web browser to implement a second communication unit that communicates with the information processing apparatus based on address information obtained from the first web application, and a second display controller that displays a screen of the second web application received by the second communication unit from the information processing apparatus. The second communication unit transmits a chat message for customizing the application, which is input to the second web application, to the information processing apparatus. The information processing apparatus includes a chat controller that transmits the chat message to the AI system in response to receiving the chat message from the terminal apparatus, and a communication unit that communicates with the terminal apparatus. The chat controller transmits, to the generative AI system, setting information related to generation of a program code and information for calling a predefined function. When the chat controller receives a request transmitted from the generative AI system based on the chat message, the setting information, and the information for calling, the communication unit transmit the request to the second web browser. The terminal apparatus further includes a program generator, a second inter-browser linking unit, and a customizer. The program generator functions by executing the predefined function, and generates the program code related to the request based on a parameter included in the request. The second inter-browser linking unit transmits the program code to the first web browser. The customizer customizes the application provided by the application service, with execution of the predefined function, by adding the program code to the application.

1. An information processing apparatus communicably connected with a terminal apparatus and a generative artificial intelligence (AI) system via a network, the apparatus comprising circuitry configured to:
transmit, to the generative AI system, a chat message received from the terminal apparatus, setting information related to generation of a program code, and information for calling a function;
receive a request from the generative AI system, the request being transmitted by the generative AI system based on the chat message, the setting information, and the information for calling the function;
with execution of the function, generate the program code related to the request based on a parameter included in the request.

2. The information processing apparatus of claim 1, wherein
in response to receiving the request from the generative AI system, the circuitry is configured to transmit to the terminal apparatus a confirmation message for confirming whether the program code related to the request is to be generated, and
in a case where a response to the confirmation message from the terminal apparatus indicates that the program code related to the request is to be generated, the circuitry is configured to generate the program code related to the request based on the parameter included in the request.

3. The information processing apparatus of claim 1, wherein
the parameter is described in a JavaScript Object Notation (JSON) format.

4. The information processing apparatus of claim 1, wherein,
in response to receiving a response message from the generative AI system, the response message being transmitted from the generative AI system based on the chat message, the setting information, and the information for calling the function,
the circuitry is configured to transmit the response message to the terminal apparatus.

5. The information processing apparatus of claim 4, wherein
in a case where the response message from the generative AI system includes the request for adding the program code, the circuitry is configured to generate the program code based on the parameter included in the received request, and
in a case where the response message from the generative AI system does not include the request for adding the program code, the circuitry is configured to transmit the response message to the terminal apparatus.

6. The information processing apparatus of claim 1, wherein
the information for calling the function includes specification settings of the function to be called by the generative AI system, and
the request received from the generative AI system is a request for calling the function having been transmitted by the generative AI system based on specification settings of the function and including a request for adding the program code.

7. The information processing apparatus of claim 3, wherein the circuitry is configured to:
acquire a name of an application item from an application to which the program code is added;
transmit the acquired name of the application item to the generative AI system as information related to the application to which the program code is to be added;
receive the parameter related to the name of the application item from the generative AI system;
generate the program code using the name of the application item based on the parameter related to the name of the application item; and
add the program code that is generated to the application to customize the application.

8. The information processing apparatus of claim 7, wherein
the circuitry is configured to communicate with an application service that executes the application via the network, and
add the program code by calling an API published by the application service.

9. The information processing apparatus of claim 7, wherein
in response to receiving the request from the generative AI system, the request including a request for adding the program code,
the circuitry is configured to transmit the program code that is generated to the terminal apparatus before adding the program code to the application, and
in response to receiving an instruction to add the program code from a user, the circuitry is configured to add the program code to the application.

10. The information processing apparatus of claim 7, wherein
in response to receiving the request from the generative AI system, the request including a request for adding the program code,
the circuitry is configured to receive, with the parameter, an explanatory text of the program code from the generative AI system,
transmit the explanatory text to the terminal apparatus before adding the program code to the application, and
in response to receiving an instruction to add the program code from a user, the circuitry is configured to add the program code to the application.

11. The information processing apparatus of claim 8, wherein the application has data registered in a field of a table, and
in a case where the chat message transmitted from the terminal apparatus indicates that only one piece of data is to be set in one field, the program code to be added causes the application to determine whether only one piece of data is registered in one field, and display an error when the number of pieces of data registered in one field is not one.

12. The information processing apparatus of claim 8, wherein the application has data registered in a field of a table, and
in a case where the chat message transmitted from the terminal apparatus indicates that a number of characters of data set in one field is to be set in another field, the program code to be added causes the application to set the number of characters of the data set to be equal between one field and the other field.

13. The information processing apparatus of claim 8, wherein the application has data registered in a field of a table, and
in a case where the chat message transmitted from the terminal apparatus specifies a data format to be set in the field, the program code to be added causes the application to display information indicating that the data in the field is to have a specific data format when the data in the field does not have the specific data format.

14. A program generation system comprising:
a terminal apparatus; and
an information processing apparatus communicably connected with the terminal apparatus and a generative AI system via a network,
the terminal apparatus including terminal circuitry configured to transmit a chat message related to an application, and
the information processing apparatus including apparatus circuitry configured to:
transmit, to the generative AI system, the chat message received from the terminal apparatus, setting information related to generation of a program code for the application, and information for calling a function;
receive a request from the generative AI system, the request being transmitted by the generative AI system based on the chat message, the setting information, and the information for calling the function;
with execution of the function, generate the program code related to the request based on a parameter included in the request.

15. The program generation system of claim 14, wherein
in response to receiving the request from the generative AI system, the apparatus circuitry is configured to transmit a confirmation message for confirming whether the program code related to the request is to be generated to the terminal apparatus, and
in a case where a response to the confirmation message from the terminal apparatus indicates that the program code related to the request is to be generated, the apparatus circuitry is configured to generate the program code related to the request based on the parameter included in the received request.

16. A program generation method, performed by an information processing apparatus communicably connected with a terminal apparatus and a generative artificial intelligence (AI) system via a network, the method comprising:
transmitting, to the generative AI system, a chat message received from the terminal apparatus, setting information related to generation of a program code, and information for calling a function;
receiving a request from the generative AI system, the request being transmitted by the generative AI system based on the chat message, the setting information, and the information for calling the function; and
generating the program code related to the request based on a parameter included in the request, with execution of the function.

17. The program generation method of claim 16, further comprising:
transmitting to the terminal apparatus a confirmation message for confirming whether the program code related to the request is to be generated, in response to receiving the request from the generative AI system; and
generating the program code related to the request based on the parameter included in the request, in a case where a response to the confirmation message from the terminal apparatus indicates that the program code related to the request is to be generated.
